(19) United States
(12) Patent Application Publication
(10) Pub. No.: US 2025/0206497 A1
(43) Pub. Date: Jun. 26, 2025

(54) RECYCLABLE CONTAINER MODULAR DISPENSING SYSTEM

(71) Applicant: C-Loop Packaging Sweden AB, Stockholm (SE)

(72) Inventors: Nicholas Guy Paget, Stockholm (SE); Matthew Eric Batchelor, London (GB); Tim Oldland, Stockholm (SE); Paul F. Klips, Springboro, OH (US); Hannah Boggs, Dayton, OH (US); Elijah R. Perkins, Miamisburg, OH (US)

(73) Assignee: C-Loop Packaging Sweden AB, Stockholm, SW (SE)

(21) Appl. No.: 19/074,218

(22) Filed: Mar. 7, 2025

Related U.S. Application Data
(63) Continuation of application No. PCT/IB2023/062644, filed on Dec. 13, 2023.
(60) Provisional application No. 63/589,897, filed on Oct. 12, 2023.
(60) Provisional application No. 63/499,426, filed on May 1, 2023.
(60) Provisional application No. 63/387,250, filed on Dec. 13, 2022.

(51) Int. Cl. B65D 17/28; B65D 1/16; B65D 1/20

(52) U.S. Cl. CPC B65D 17/401; B65D 1/165; B65D 1/20; B65D 2517/0004

(57) ABSTRACT

Apparatus and associated methods relate to a can end having guidance features to automatically guide a reusable dispensing body to engage a predetermined region of the can end. In an illustrative example, an auto-interfacing can end (AICE) may include a structural rib disposed inward from an outer rim of the AICE. The outer rim, for example, may define a continuous top surface configured to engage a dispensing body. The continuous top surface also includes a predetermined aperture at a center region. In some implementations, the structural rib may include a vertical displacement perpendicular to a horizontal plane of the continuous top surface. For example, a score of the AICE may include check slots configured to facilitate formation of the predetermined aperture. Various embodiments may advantageously self-align the reusable dispensing body to the center of the continuous top surface when the reusable dispensing body is advancing towards the can end.

### CROSS-REFERENCE TO RELATED APPLICATIONS

This application claims the benefit of U.S. Provisional Application Ser. No. 63/387,250, titled “Recyclable Container Modular Dispensing System,” filed by Nicholas Guy Paget, et al., on Dec. 13, 2022.

This application also claims the benefit of U.S. Provisional Application Ser. No. 63/499,426, titled “Recyclable Modular Dispensing System Interface,” filed by Nicholas Guy Paget, et al., on May 1, 2023.

This application also claims the benefit of U.S. Provisional Application Ser. No. 63/589,897, titled “Reusable Dispensing Cap for Recyclable Container and Closure,” filed by Paul F. Klips, et al., on Oct. 12, 2023.

This application also claims the benefit of International Publication No. WO/2024/127281, titled “RECYCLABLE CONTAINER MODULAR DISPENSING SYSTEM,” filed by Nichols Guy Paget, et al., on Dec. 13, 2023.

This application incorporates the entire contents of the foregoing applications herein by reference.

### TECHNICAL FIELD

Various embodiments relate generally to reusable dispensers, container can end, accessories related to recyclable dispensing systems, and some combination thereof.

### BACKGROUND

Containers are ubiquitous in our daily lives. For example, they may be used to hold a wide variety of contents ranging from food items and personal care products to industrial chemicals and hazardous materials. The containers, for example, may come in various shapes, sizes, and materials such as plastic bottles, metal cans, and sealed pouches.

Depending on the nature of the contents and the desired level of protection, containers may include various closing mechanisms (e.g., screw-on or snap-on lids). For example, a shampoo bottle may have a snap-on lid while a soap bottle may have a screw-on lid. Unitarily formed containers (e.g., with sealed pouches) may be another type of container. For example, the unitarily formed container may not include a separate closing mechanism. For example, a user may need to cut or tear an aperture in the pouch to access the contents.

One design aspect of a container in recent years may be environmental impacts of containers. Various efforts may be underway to reduce the use of single-use containers and to promote the use of recyclable and biodegradable materials. In some cases, innovative container designs, including, for example, collapsible or reusable containers, may be gaining popularity as a more sustainable alternative to traditional disposable containers.

### SUMMARY

Apparatus and associated methods relate to a can end having guidance features to automatically guide a reusable dispensing body to engage a predetermined region of the can end. In an illustrative example, an auto-interfacing can end (AICE) may include a structural rib disposed inward from an outer rim of the AICE. The outer rim, for example, may define a continuous top surface configured to engage a dispensing body. The continuous top surface also includes a predetermined aperture at a center region. In some implementations, the structural rib may include a vertical displacement perpendicular to a horizontal plane of the continuous top surface. For example, a score of the AICE may include check slots configured to facilitate formation of the predetermined aperture. Various embodiments may advantageously self-align the reusable dispensing body to the center of the continuous top surface when the reusable dispensing body is advancing towards the can end.

Various embodiments may achieve one or more advantages. For example, some embodiments may advantageously prevent a dip tube of the dispensing body from being caught by a sharp edge of the predetermined aperture. Some embodiments, for example, may advantageously include engagement features to facilitate engagement from a flat hammer module. For example, some embodiments may advantageously resist a residual downward force at the can end. Some embodiments, for example, advantageously prevent engagement by the dispensing body using a spacer module. For example, some embodiments may include a transportation arrangement to advantageously avoid accidental breaking of the can end during transportation. Some embodiments may, for example, advantageously prevent rolling of a sealing feature around the hammer module. For example, some embodiments may advantageously include anti-rotational features.

The details of various embodiments are set forth in the accompanying drawings and the description below. Other features and advantages will be apparent from the description and drawings, and from the claims.

### BRIEF DESCRIPTION OF THE DRAWINGS

FIG. 1A, FIG. 1B, FIG. 1C, and FIG. 1D depict an exemplary auto-interfacing can end (AICE) having a ridge feature.

FIG. 2A and FIG. 2B depict an exemplary AICE with an underside score line.

FIG. 2C and FIG. 2D depict an exemplary AICE with a score line.

FIG. 3 depicts an exemplary domed-shaped AICE.

FIG. 4 depicts an exemplary friction reducing AICE.

FIG. 5A depicts an exemplary three-piece container.

FIG. 5B and FIG. 5C depict an exemplary cone shape bottom end in a first embodiment in an exemplary use case scenario.

FIG. 5D and FIG. 5E depict an exemplary cone shape bottom end in a second embodiment in an exemplary use case scenario.

FIG. 6A and FIG. 6B depict an exemplary dip tube.

FIG. 7A, FIG. 7B, and FIG. 7C depict an exemplary valved insert.

FIG. 7D and FIG. 7E depict an exemplary valved insert employed in an exemplary container.

FIG. 7F, FIG. 7G, and FIG. 7H are close-up diagrams showing exemplary components of an exemplary AICE having an exemplary valved insert in a second embodiment.

FIG. 7I and FIG. 7J depict an exemplary AICE having the exemplary one-way valve described with reference to FIGS. 7F-7G.

FIG. 8A is a cross-sectional view of an exemplary self-closing AICE.

FIG. 8B is a closed-up perspective view of the exemplary self-closing AICE described with reference to FIG. 8A.

FIG. 8C, FIG. 8D, FIG. 8E, FIG. 8F, FIG. 8G, and FIG. 8H depict exemplary embodiments of an exemplary self-closing AICE as described with reference to FIGS. 8A-8B.

FIG. 9A depicts an exemplary dispensing cartridge employed in an exemplary use case scenario.

FIG. 9B, FIG. 9C, and FIG. 9D depict an exemplary filter cartridge.

FIG. 9E, FIG. 9F, FIG. 9G, and FIG. 9H depict exemplary embodiments for mixing multiple components in an exemplary dispensing cartridge.

FIG. 10A, FIG. 10B, FIG. 10C, FIG. 10D, and FIG. 10E depict exemplary anti-rotation AICEs.

FIG. 11 depicts an exemplary open score AICE.

FIG. 12A and FIG. 12B depict an exemplary dispenser spacer.

FIG. 12C depicts an exemplary internal spacer tube.

FIG. 12D depicts an exemplary transportation arrangement using the exemplary dispenser spacer described with reference to FIGS. 12A-B.

FIG. 12E depicts an exemplary removable shield disposed between a punch module and the can end.

FIG. 13A, FIG. 13B, and FIG. 13C depicts an exemplary top component of a container having a hammer element.

FIG. 14A and FIG. 14B depict an exemplary dispensing engine having an exemplary retaining pump flange.

FIG. 15A and FIG. 15B depict an exemplary AICE without a ball valve.

FIG. 16A and FIG. 16B depict an exemplary AICE having an exemplary safety edge.

FIG. 16C and FIG. 16D depict additional embodiments of an exemplary AICE having an exemplary safety edge.

FIG. 17A and FIG. 17B depict an exemplary AICE having a depressed engagement area.

FIG. 17C and FIG. 17D depict an exemplary AICE having a raised engagement area.

FIG. 18A shows an exemplary pattern topping module.

FIG. 18B shows a top-down cross-section view of an exemplary daisy topping engine.

FIG. 18C depicts an illustrative patterned can seam.

FIG. 19A and FIG. 19B depict an exemplary 360-degree score design of an exemplary AICE having a predetermined hinge.

FIG. 20A, FIG. 20B, and FIG. 20C depict an exemplary 360-degree score design of an exemplary AICE having predetermined check slots.

FIG. 21 depicts an exemplary AICE having a sunken center panel, a 360-degree score, and an invisible hinge.

FIG. 22A and FIG. 22B depict exemplary score opening mechanisms using exemplary hammer elements, for example, as described with reference to FIGS. 13A-C.

FIG. 23A, FIG. 23B, FIG. 23C, and FIG. 23D depict exemplary design considerations of the hammer element described with reference to FIGS. 13A-C.

FIG. 24A, FIG. 24B, and FIG. 24C depicts an exemplary reusable dispenser system having a flat punch element.

FIG. 25 depicts an exemplary sealing module coupled to a punch module of an exemplary reusable dispenser.

FIG. 26 depicts an illustrative can end.

FIG. 27 depicts an illustrative engagement member.

FIG. 28 depicts an illustrative can.

FIG. 29 depicts an illustrative dispenser.

Like reference symbols in the various drawings indicate like elements.

### DETAILED DESCRIPTION OF ILLUSTRATIVE EMBODIMENTS

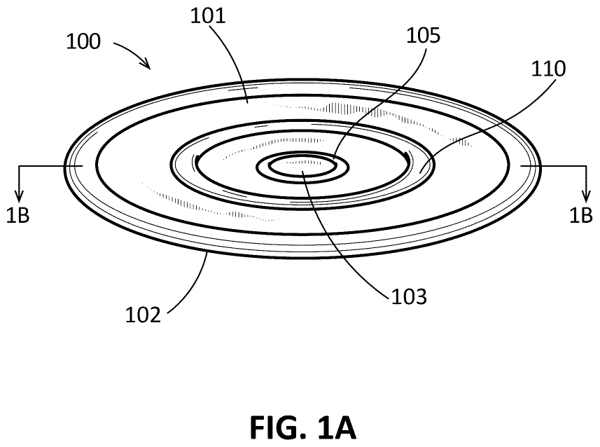

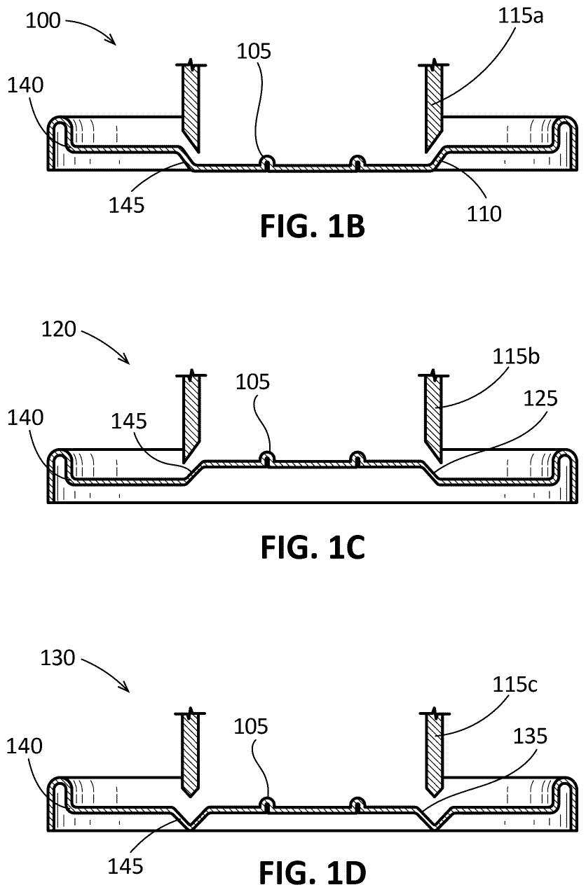

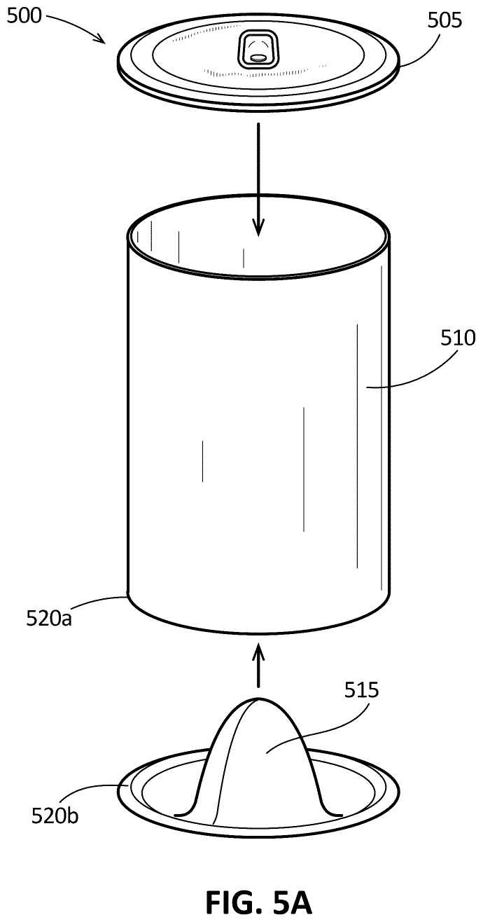

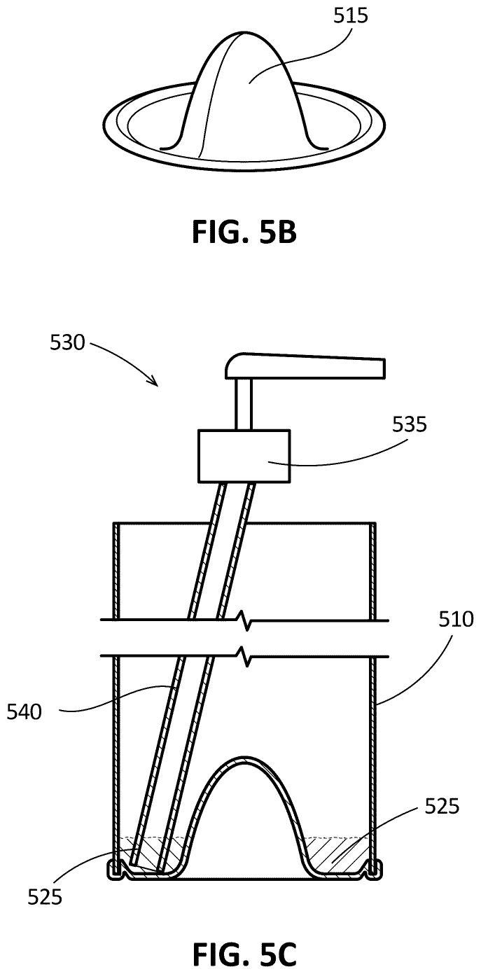

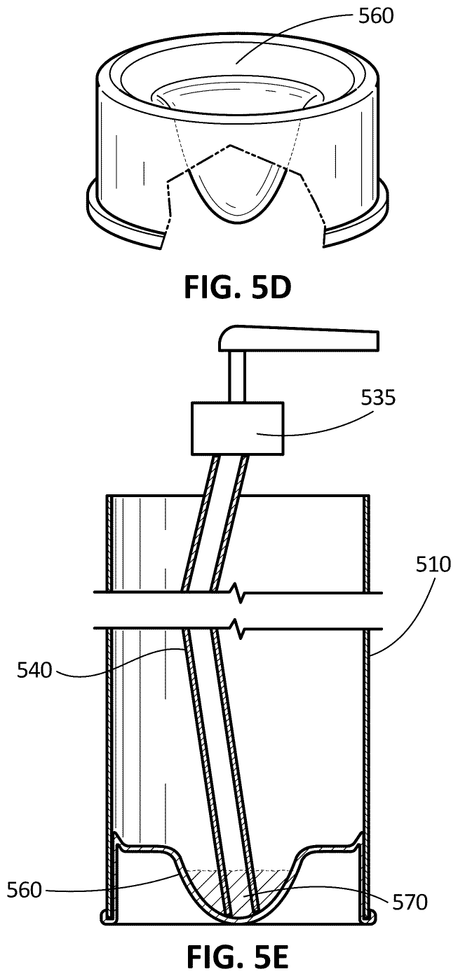

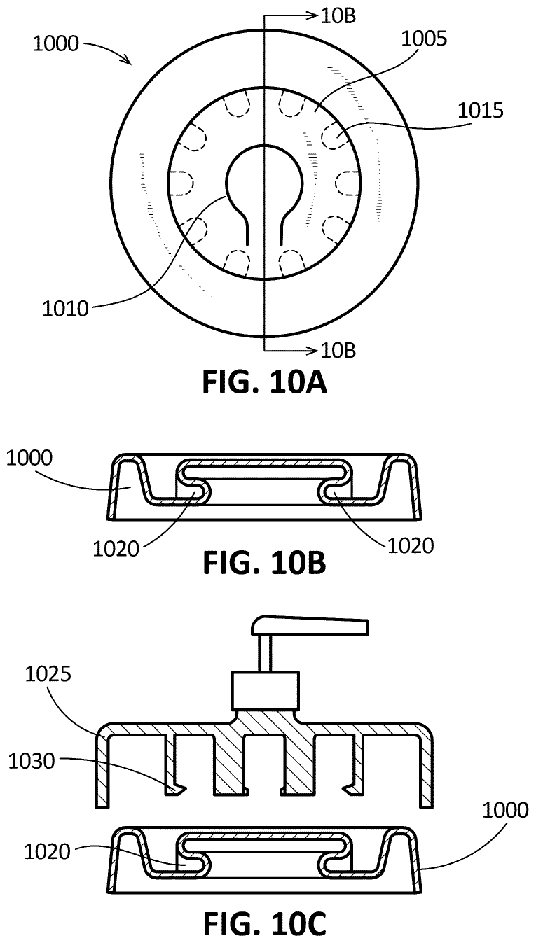

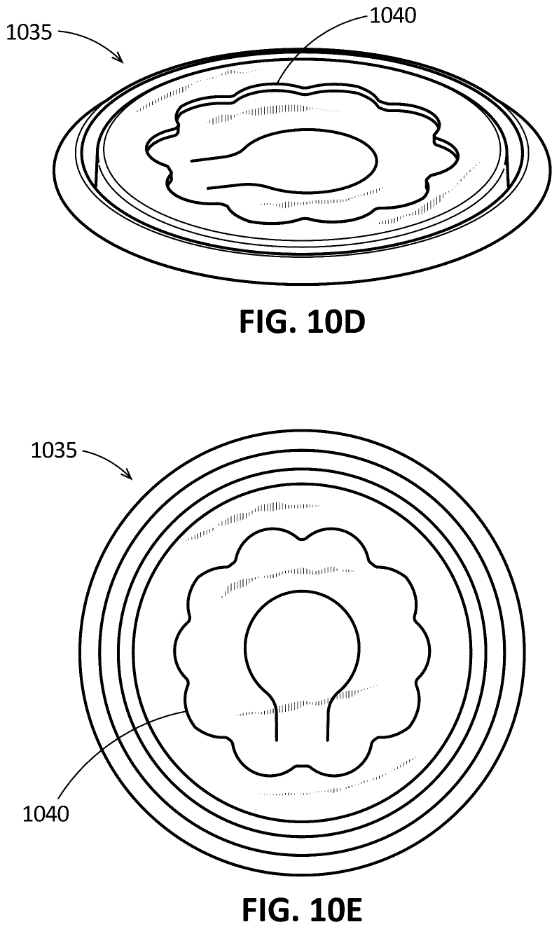

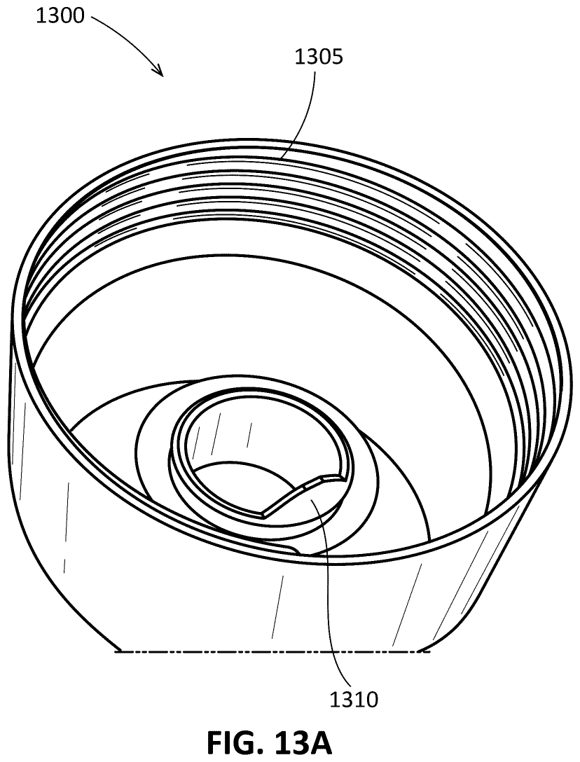

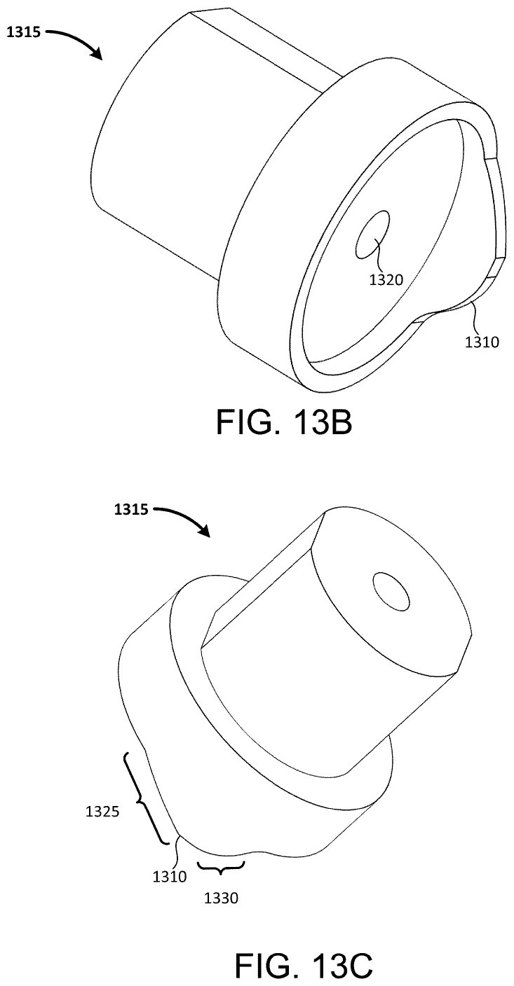

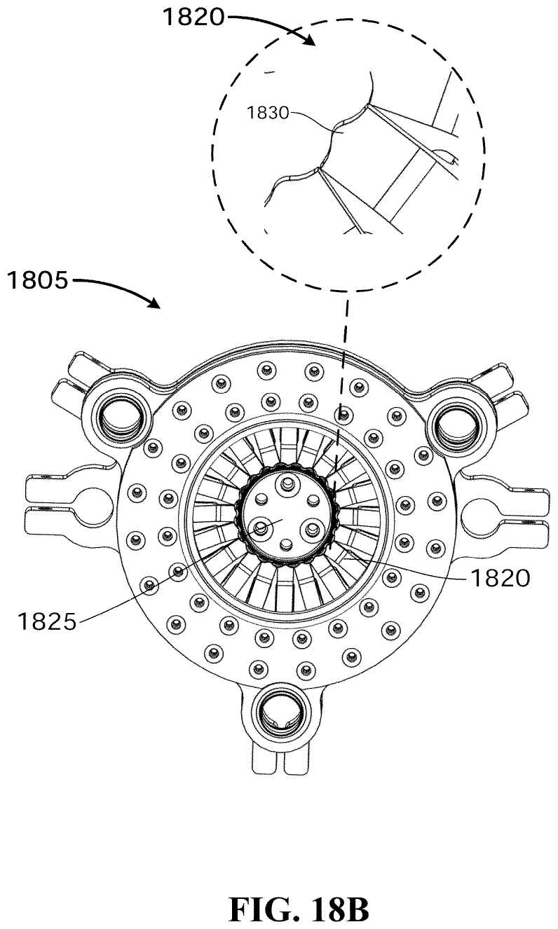

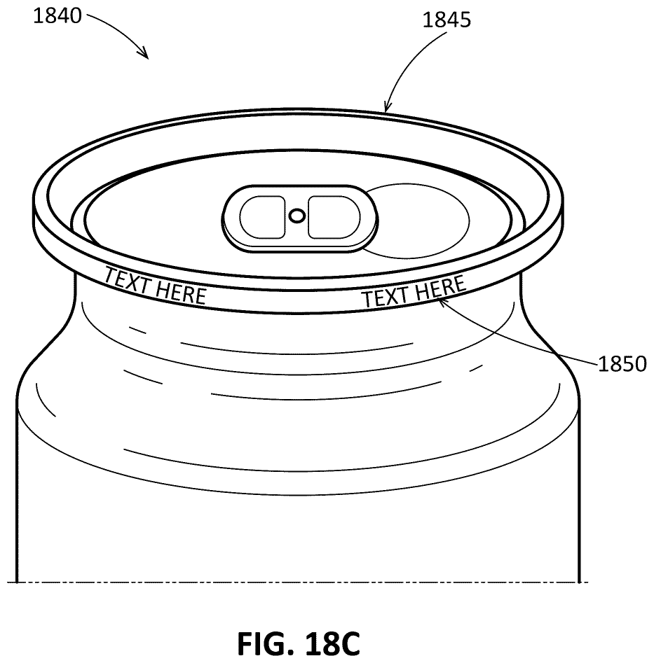

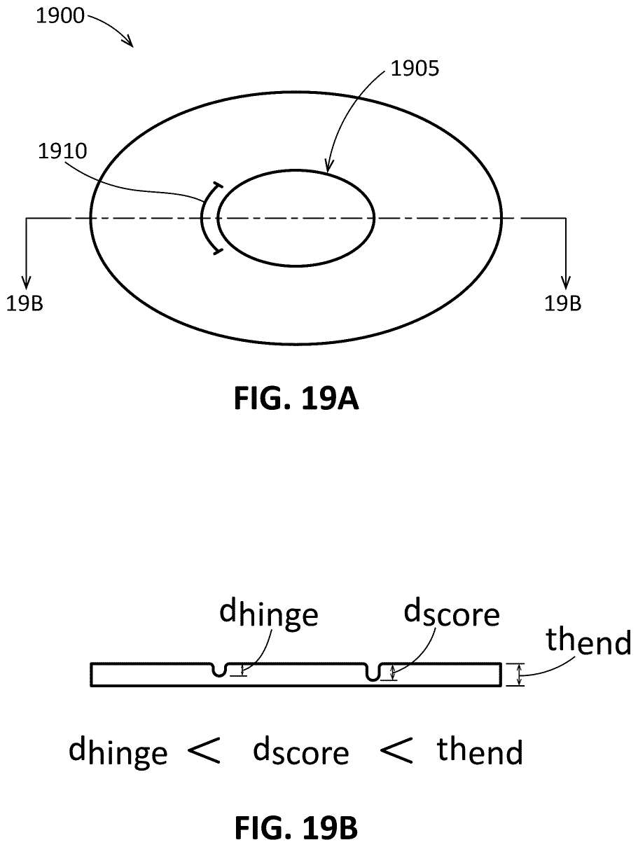

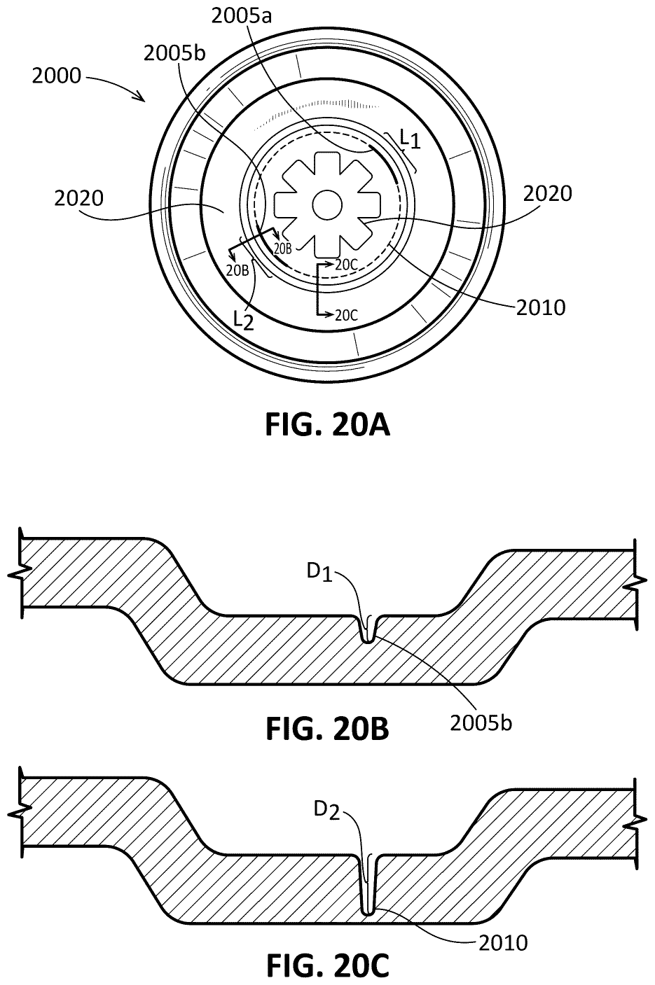

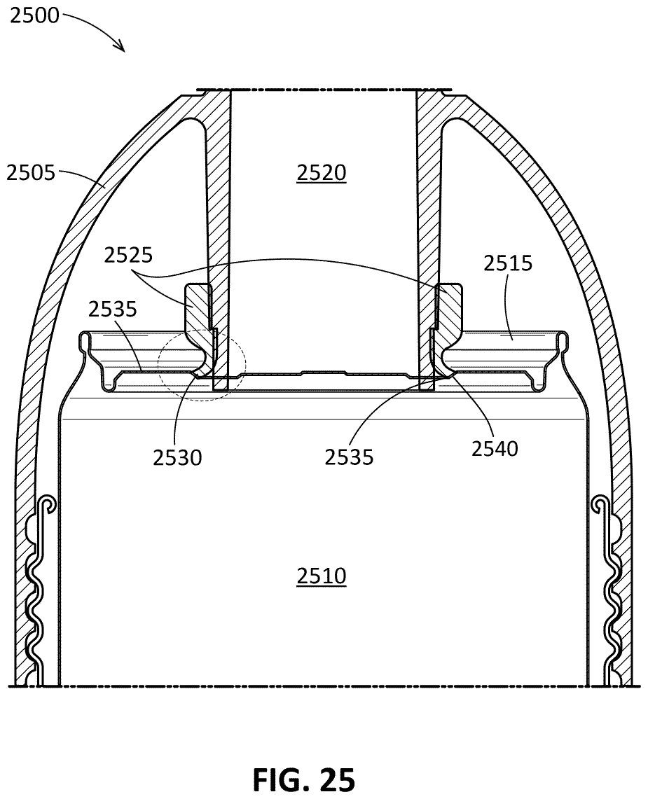

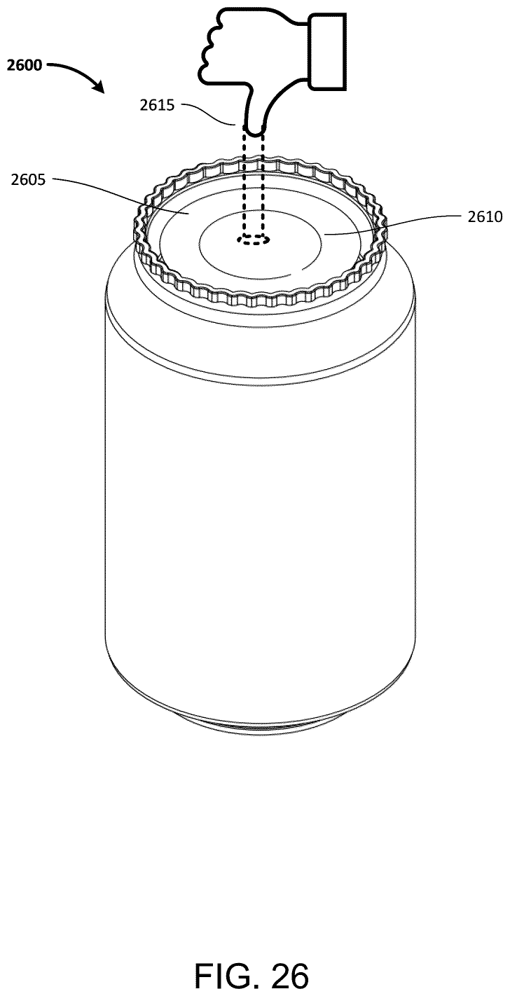

To aid understanding, this document is organized as follows. First, to help introduce discussion of various embodiments, an auto-interfacing can end (AICE) is introduced with reference to FIGS. 1A-4. Second, that introduction leads into a description with reference to FIGS. 5A-9H of some exemplary embodiments of containers, cartridges, and dispensing components using the AICE. Third, with reference to FIGS. 10A-12D, various features of a reusable container system are described in application to exemplary AICEs. Fourth, with reference to FIGS. 13A-17D, the discussion turns to exemplary embodiments that illustrate safety edges of exemplary AICEs and hammer elements of exemplary reusable dispensers. Fifth, and with reference to FIG. 18A-C, this document describes exemplary apparatus and methods useful for manufacturing an AICE. Sixth, this disclosure turns to a review of various embodiments of a score in relations with the hammer elements with reference to FIGS. 19A-24C. Various embodiments of sealing components of an exemplary reusable dispensing system are reviewed with reference to FIG. 25. Embodiments of a can end, a dispensing mechanism, and a can are depicted with reference to FIGS. 26-28. Finally, the document discusses further embodiments, exemplary applications and aspects relating to reusable dispensing systems.

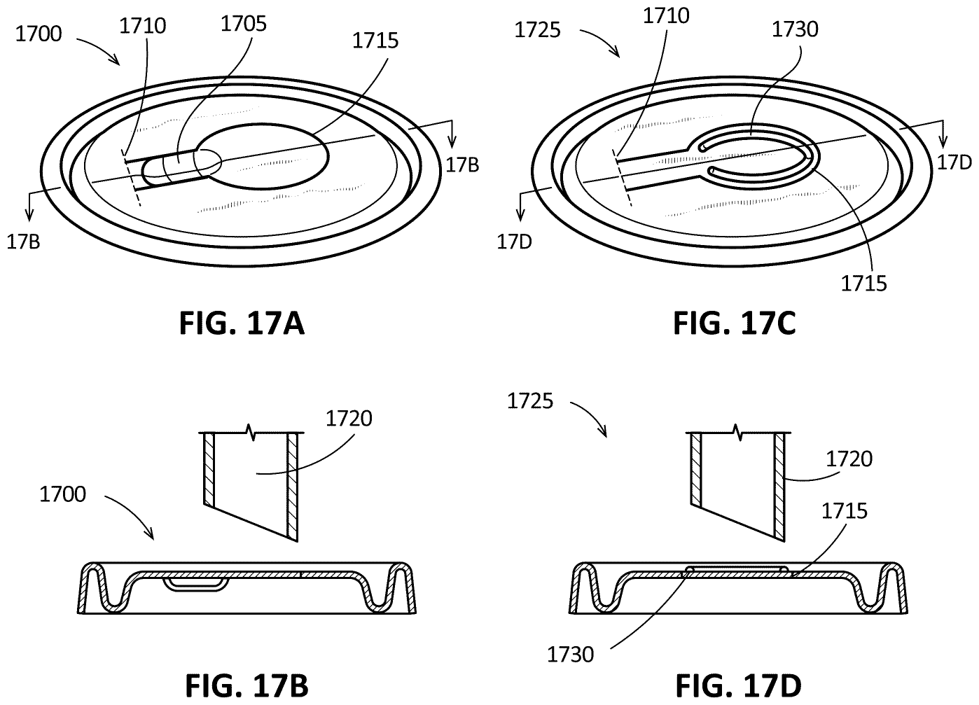

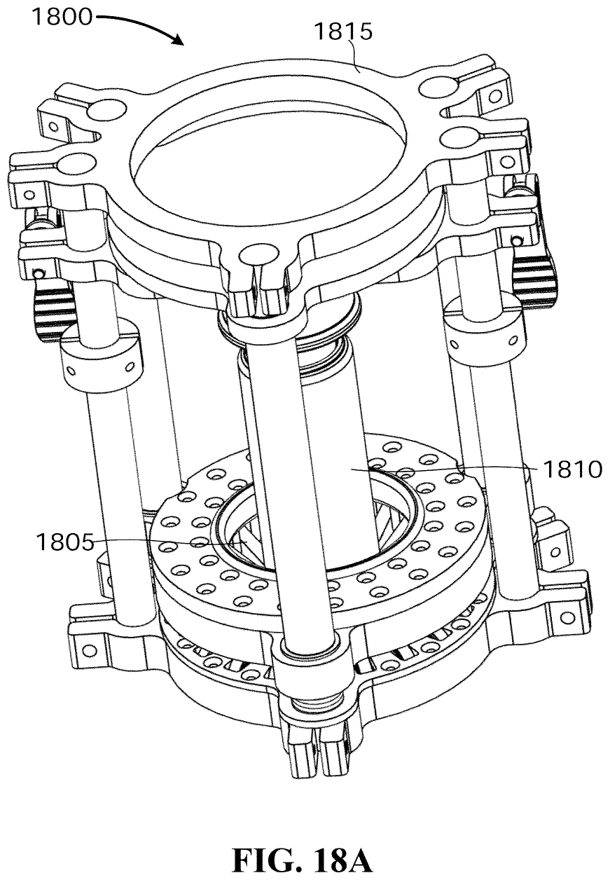

FIG. 1A, FIG. 1B, FIG. 1C, and FIG. 1D depict an exemplary auto-interfacing can end (AICE) having a ridge feature. In this example, an AICE 100 includes a top surface 101 defined by an outer rim 102 of the AICE 100. For example, the top surface 101 may be continuous. As shown in FIG. 1A, an AICE 100 includes a structural rib 105 and a sealing surface end 110. For example, the AICE 100 may be used as a can end of a dispensing assembly. In some examples, the structural rib 105 may include a ridge structure encircling a predetermined aperture 103 of the AICE 100. In some implementations, the structural rib 105 may be configured in accordance with various embodiments of score lines, such as described in FIG. 17 and FIG. 20 in the WIPO Patent Application Serial No. PCT/IB2021/060067, the entire contents of which are incorporated herein by reference.

For example, the AICE 100 may include a score (e.g., as disclosed at least with reference to numeral 1710 in FIG. 17 of the WIPO Patent Application Serial No. PCT/IB2021/060067), which may be interrupted by a bridge. The score may, for example, correspond to a thinner region of material and/or a depressed region of material. For example, the score may define a region of higher stress concentration in the AICE 100. The bridge may, for example, correspond to a thicker (e.g., full thickness) region of material. For example, the bridge may define a region corresponding to lower stress concentration in the AICE 100 than the score.

As shown in FIG. 1B, a cross-sectional diagram of the AICE 100 along a line 1B-1B is shown. In this example, a sealing structure 115a (e.g., of a pump, of a container cap) is engaged with the AICE 100 at the sealing surface end 110. For example, the sealing surface end 110 may be configured to include a mating feature matching with the sealing structure to advantageously facilitate an engagement and seals between the AICE 100 and the sealing structure 115a. In some implementations, the structural rib 105 may advantageously provide a predetermined region (e.g., for a straw) to break the AICE 100.

In various embodiments, the sealing surface end 110 may include a vertical displacement 145 from a horizontal surface 140 of the AICE 100. FIGS. 1C-D show other embodiments of the AICE having the structural rib 105. As shown in FIG. 1C, an AICE 120 includes an elevated sealing surface end 125. For example, the elevated sealing surface end 125 may be configured such that the structural rib 105 may be in an elevated region as shown in FIG. 1C. A sealing structure 115b as shown includes a mating feature matching a mating feature of the elevated sealing surface end 125.

An AICE 130, as shown in FIG. 1D, includes a groove sealing surface end 135. A sealing structure 115c as shown includes a mating feature matching to a mating feature of the groove sealing surface end 135. Various embodiments may be configured to fit various sealing structures of container caps, for example.

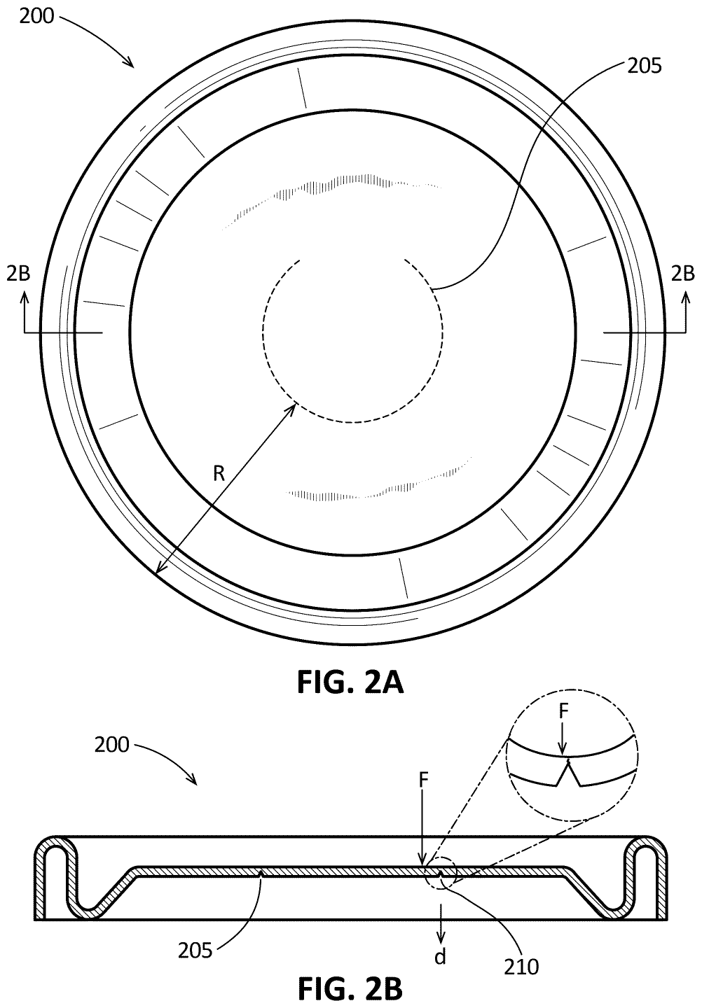

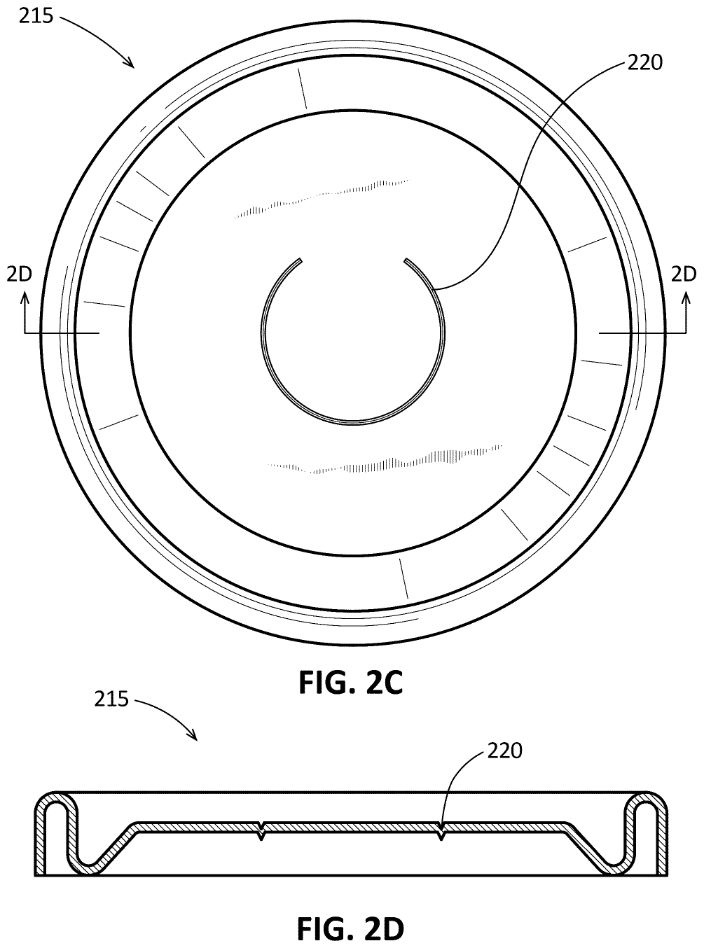

FIG. 2A and FIG. 2B depict an exemplary AICE with an underside score line. In this example, an AICE 200 (e.g., the AICE 100) includes a score 205 in a reverse side (e.g., a bottom surface of the AICE 200 when coupled to a container). In some examples, the score 205 may be located at a central region of the AICE 200. For example, the score 205 may be forced open by a hammer element of a reusable dispenser. For example, after open, the score 205 may define a predetermined aperture to access internal content within a container enclosed by the AICE 200. In this example, a distance of the score 205 from an outer rim of the AICE 200 may be substantially equal (R). For example, a centered score line may advantageously enable an automatic alignment of a hammer element of a dispenser to align with the score 205 independent of an initial engagement angle between the hammer element and the AICE 200.

In some implementations, the AICE 100 and the AICE 200 may be combined to include the structural rib 105 and the score 205. For example, the structural rib 105 may advantageously provide a centering alignment for a punch (e.g., the sealing structure 115a, the sealing structure 115b, the sealing structure 115c) relative to the score 205. For example, the structural rib 105 may advantageously guide (e.g., self-align) a hat (e.g., a dispensing unit engaging the AICE 100/the AICE 200) to a center of the AICE 100, so that the hat and the AICE may be concentric within tolerances.

In various implementations, a can end (e.g., AICE 100) of a container may include a predetermined aperture at a center and a uniform sealing surface (e.g., the sealing surface end 110) disposed inward from an outer rim that circumscribes the predetermined aperture region. For example, the uniform sealing surface may include a vertical displacement (e.g., the vertical displacement 145) along a horizontal plane (e.g., the horizontal surface 140) of a continuous surface of the can end.

FIG. 2B is a cross-sectional view of the AICE 200. As shown, the AICE 200 includes the score 205. The score 205 may be formed on an underside of the AICE 200. In various implementations, the score 205 may advantageously reduce a force (e.g., 50 N, 80 N, 100 N) required to break the AICE 200. In this example, a compound 210 is added to a surface between the score 205 and the AICE 200. For example, the compound 210 may be added after the score 205 has been created. For example, the compound may advantageously protect the score 205 from exposure to a content (e.g., hazardous, toxic, flammable) contained in a container coupled to the AICE 200. For example, the compound may resist corrosion and/or unexpected failure.

Without being bound to a particular theory, when a force F (e.g., by a dispensing lid) is applied to the AICE 200 (e.g., by coupling a can opening RDE to the AICE 200), the force F may induce a displacement d of the AICE 200. The displacement d may cause a highly concentrated stress concentration at the peak of the score 205. The highly concentrated stress concentration may induce localized (e.g., controlled) material failure beginning at a top of the score 205 and propagating upward towards the opposite side (e.g., the top) of the AICE 200. For example, the material failure may propagate upwards as the stress concentration moves upwards as the material fails, as shown by the jagged edges in the close-up view of the score 205. As depicted, the force F may be applied at a predetermined location adjacent to the score 205.

FIG. 2C and FIG. 2D depict an exemplary AICE with a score line. For example, an AICE 215 may be configured as an embodiment of the AICE 200. In this example, the AICE 215 includes a score 220 on a top surface of the AICE 215. FIG. 2D depicts a cross-section view of the AICE 215 depicted in the FIG. 2C. For example, a compound (e.g., the compound 210) may be added to the top surface between the score 220 and the AICE 200.

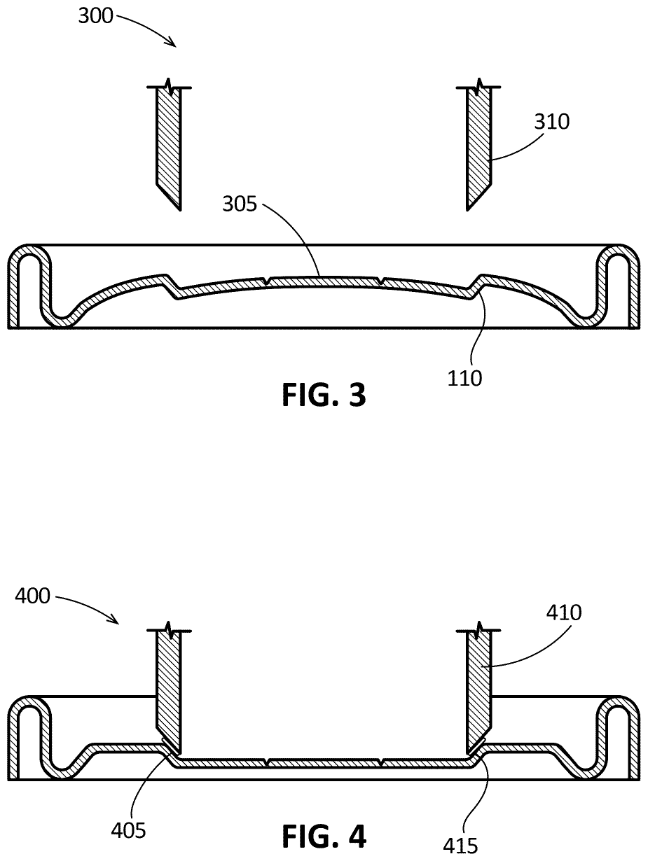

FIG. 3 depicts an exemplary domed-shaped AICE. In this example, the AICE 300 includes a curved profile region 305. For example, the curve profile may include a dome shape. For example, the curve profile may include a convex shape. For example, when (a hammer element of) a dispenser 310 engages the sealing surface end 110, a pressure within a container enclosed by the AICE 300 may decrease. For example, a downward force may be generated at a top surface of an engaging AICE. In some examples, the downward force may deform the sealing assembly of the AICE. For example, the deformed sealing assembly may compromise an air-tight feature of a container. The curved profile region 305 may be configured to advantageously resist the downward force, for example.

For example, some embodiments may advantageously maintain a minimum upward curvature (e.g., the ‘domed’ shape) even when contents of the can are not pressurized. Such minimum upward curvature may, for example, advantageously maintain sealing contact with a sealing surface of the dispenser 310. For example, the minimum upward curvature may be configured as a ‘spring’ to maintain sealing contact with the dispenser 310. In some implementations, for example, material of the AICE 300 may include a spring-material (e.g., spring steel). For example, the spring material may be chosen to have a minimum modulus of elasticity and/or minimum elastic region. The spring material may, for example, be selected based on a target sealing force when coupling with the dispenser 310 and/or with a target displacement distance when coupling with the dispenser 310.

In various implementations, a can end (e.g., the AICE 300, the AICE 200, the AICE 100) may include a curved profile (e.g., the curved profile region 305) configured to curve towards the dispensing body (e.g., the dispenser 310) during engagement. For example, the curved profile of the can end may advantageously resist a residual downward force resulting from the engagement.

FIG. 4 depicts an exemplary friction reducing AICE. In this example, an AICE 400 includes friction reducing material (FRM 405) on a predetermined region on a top surface. For example, the FRM 405 may include a hard wax. For example, the FRM 405 may include lubricating oil. For example, the FRM 405 may include a friction reducing coating. For example, the FRM 405 may include friction reducing compounds (e.g., PTFE, silicon).

In some implementations, by way of example and not limitation, the predetermined region of the AICE 400 may be configured to receive and/or retain the FRM 405. For example, the AICE 400 may have a trough and/or indentation band to receive the FRM 405.

In some implementations, by way of example and not limitation, the FRM 405 may be applied as a fluid. In some implementations, for example, the FRM 405 may be applied as a powder.

In various implementations, the FRM may be applied to allow an engaging sealing member 410 (e.g., O-rings, mating surface) to slide. For example, when the engaging sealing member 410 engages the AICE 400, the engaging sealing member 410 may slide at tapered regions 415 to reduce stiction. For example, the FRM may advantageously allow deeper engagement between the engaging sealing member 410 and the AICE 400. The FRM may, for example, have a lower coefficient of friction than the engaging sealing member 410 and/or the tapered regions 415.

FIG. 5A depicts an exemplary three-piece container. FIG. 5B and FIG. 5C depict an exemplary cone shape bottom end in a first embodiment in an exemplary use case scenario. As shown in FIG. 5A, a container 500 includes a ring-pull AICE 505, a can body 510, and a can bottom 515. In this example, the can body 510 may include a seam 520a (e.g., formed when the can body 510 is seamed to the can bottom 515). For example, the seam 520a may be configured to engage with a seam 520b (e.g., formed when the can body 510 is seamed to the can bottom 515). of the can bottom 515. In some implementations, other engagement mechanisms may be used to engage between the ring-pull AICE 505 and the can body 510, and between the can body and the can bottom 515.

FIG. 5B shows a close-up view of the can bottom 515. As shown, the can bottom 515 may include a cone shape. For example, the cone shaped configuration of the can bottom 515 may advantageously allow easy retrieval of content at a bottom of the container 500. For example, the cone shape may induce contents of the can to accumulate in the well formed by the cone. Accordingly, a volume of contents may be advantageously accessed and drained which would otherwise have been inaccessibly spread over the surface of the AICE. Accordingly, such implementations may advantageously reduce waste.

In an illustrative example shown in FIG. 5C without limitation, the can bottom 515 directs content to a (peripheral) well 525 of a container 530. As shown, a pump 535 includes a dip tube 540 which may easily access the well 525 when the content is running low in the container 530, for example.

In some implementations, by way of example and not limitation, the well may be tilted laterally. For example, one end of the well may be lower than another end. Accordingly, contents may continue to accumulate (e.g., due to gravity) in a lower region of the well. For example, the dip tube 540 may include a length configured to reach a lowest point of the well.

FIG. 5D and FIG. 5E depict an exemplary cone shape bottom end in a second embodiment in an exemplary use case scenario. In this example, an inverted cone shape bottom end 560 is shown in FIG. 5D. In an illustrative example without limitation, The inverted cone shape bottom end 560 may direct a content of in the can body 510 to a central well 570. For example, the dip tube 540 may advantageously be directed to retrieve content at the central well 570. For example, funneling the remaining contents towards the center of the can assembly may collect the last drops of contents to reduce wastage. For example, the central well 570 may be configured such that at least 80% (e.g., more than 90%) of content may be removed by the dip tube 540.

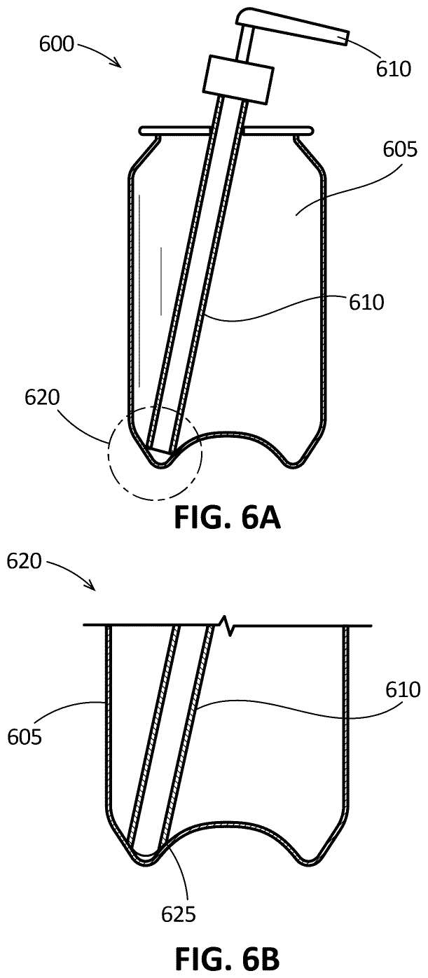

FIG. 6A and FIG. 6B depict exemplary dip tubes. In this example, a container 600 includes a can body 605. A dip tube 610 is inserted to access content in the can body 605. In this example, a bottom end of the can body 605 includes a well region 620 (e.g., the well 525, the central well 570). A closed up view of the well region 620 is shown in FIG. 6B. As shown in this example, the dip tube 610 includes a shaped end 625. For example, the shaped end 625 may be formed to match a profile of a bottom of the well region 620. For example, the shaped end 625 may advantageously reach a bottom tip of the well region 620. In some implementations, a special cutting tool may be used to cut a dip tube to fit the bottom tip of the well region 620.

In some implementations, the well region 620 may include a continuous surface having laterally tilted subregions. For example, the well region 620 may include a lowest subregion that may be lower than other subregions. For example, the lowest subregion may include a shaped profile (e.g., a cone shape). For example, the shaped end 625 may complement the shaped profile of the lowest subregion.

In various embodiments, a (reusable) dispensing body may include a profiled straw (e.g., the dip tube 610 having the shaped end 625) configured to match a bottom profile (e.g., the well region 620) of a container.

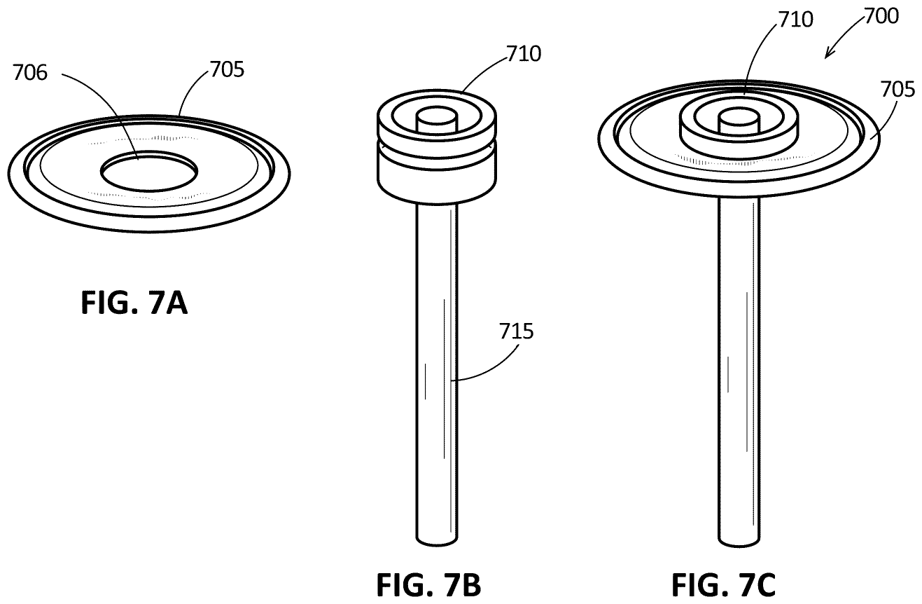

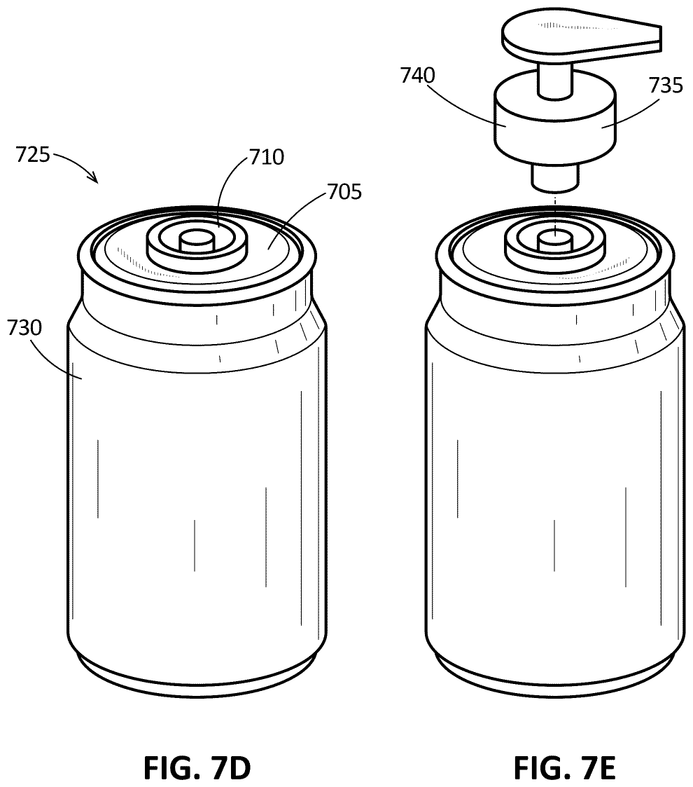

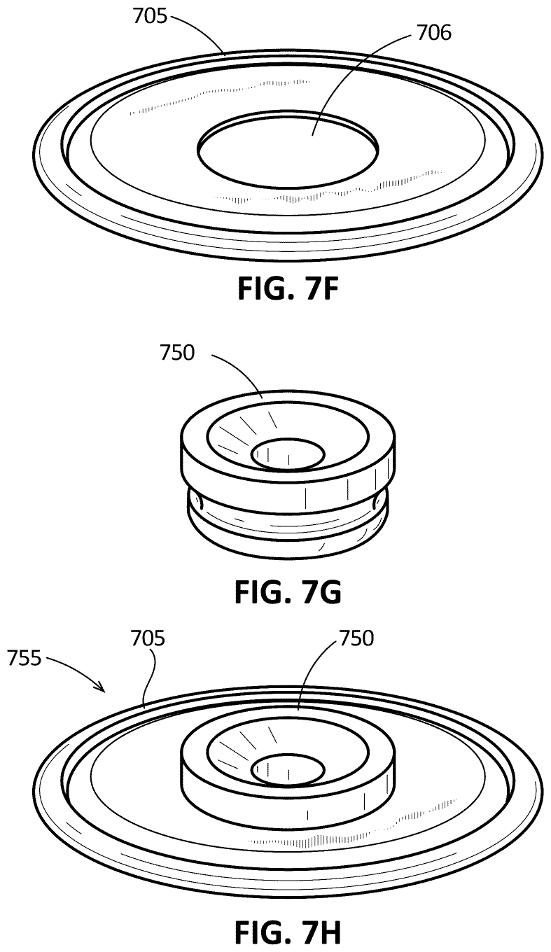

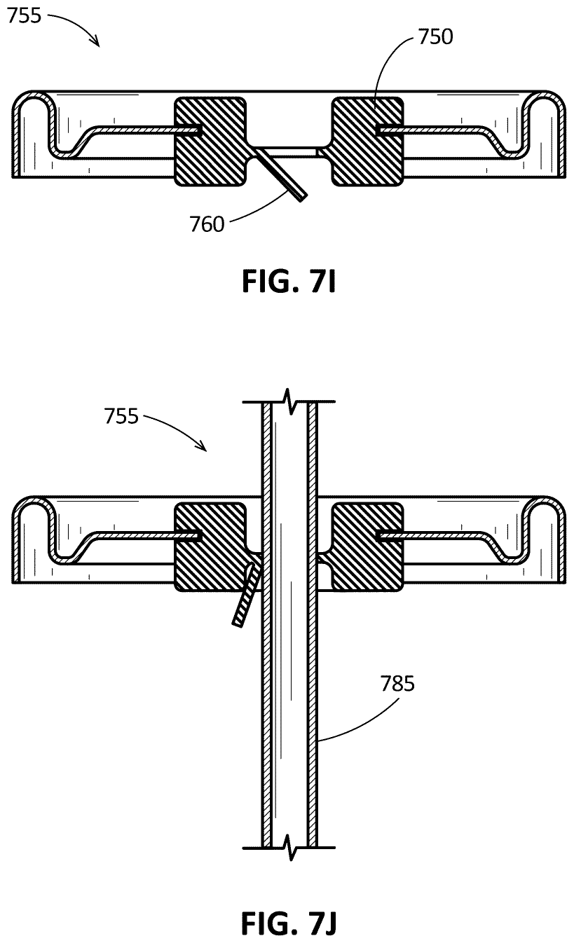

FIG. 7A, FIG. 7B, and FIG. 7C depict an exemplary valved insert. As shown in FIG. 7C, a valved insert 700 includes an AICE 705 and a one way insert module (OWIM 710). As shown in FIG. 7A, the AICE 705 includes an aperture 706. The OWIM 710, as shown in FIG. 7B, includes a dip tube 715 and a retention surface 720. For example, during assembly, the dip tube 715 may be inserted through the aperture 706, and the retention surface 720 may securely engage an edge of the aperture 706.

FIG. 7D and FIG. 7E depict an exemplary valved insert (e.g., the valved insert 700) employed in an exemplary container. As shown, a container 725 includes a can body 730. For example, the can body 730 may contain prohibited (hazardous) content. In various implementations, the OWIM 710 may include a one-way valve configured to prevent the content from escaping from the container 725 without a dispenser 735. In this example, the dispenser 735 includes a connecting cap 740. For example, the connecting cap 740 may be configured to securely form a secure seal with the OWIM 710. In some examples, the OWIM 710 may advantageously prevent consumers from accessing the prohibited content in the can body 730.

FIG. 7F, FIG. 7G, and FIG. 7H are close-up diagrams showing exemplary components of an exemplary AICE having an exemplary valve insert in a second embodiment. FIG. 7I and FIG. 7J depict an exemplary AICE having the exemplary one-way valve described with reference to FIGS. 7F-7G. As shown, the AICE 705 may be coupled to a OWIW 750 at the aperture 706 to form an assembly 755. As shown in FIG. 7I, the OWIW 750 includes an opening feature 760. For example, the opening feature 760 may be a one way valve. For example, the opening feature 760 may be an openable flap. In some implementations, the opening feature 760 may be closed in a stowed mode, preventing access to inside content contained within the assembly 755. As shown in FIG. 7J, when a dip tube 785 is inserted through the OWIW 750, the opening feature 760 may drop open to allow the dip tube 785 to access the inside content.

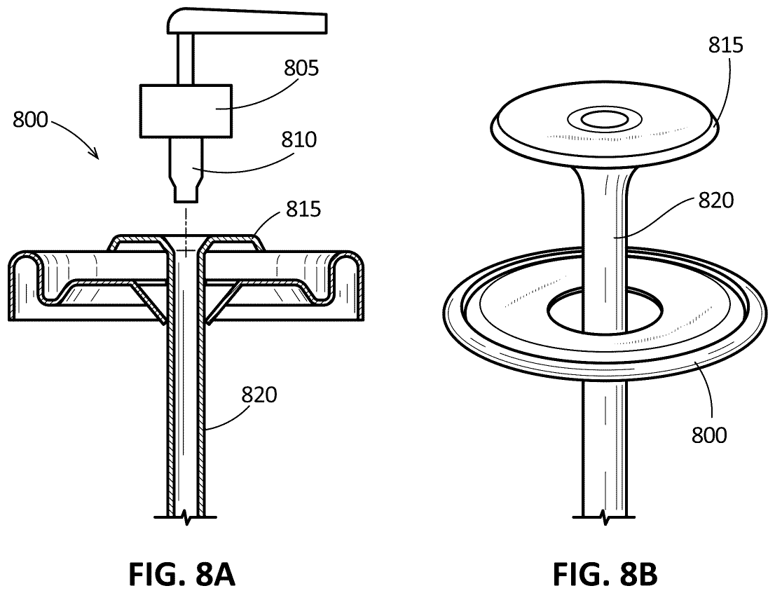

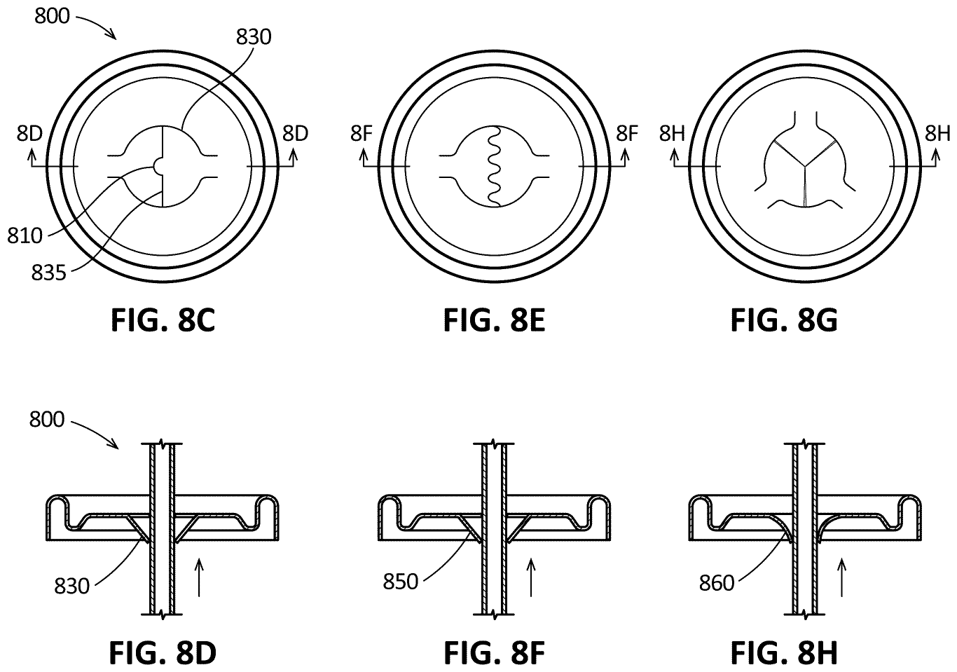

FIG. 8A is a cross-sectional view of an exemplary self-closing AICE. FIG. 8B is a closed-up perspective view of the exemplary self-closing AICE described with reference to FIG. 8A. As shown, a self-closing AICE (SCCE 800) may receive a dispenser 805. In this example, the dispenser 805 includes a plunger 810. The plunger 810, in this example, is received by a tube assembly that includes a flanged cover 815 and a dip tube 820.

FIG. 8C, FIG. 8D, FIG. 8E, FIG. 8F, FIG. 8G, FIG. 8H depict exemplary embodiments of an exemplary self-closing AICE as described with reference to FIGS. 8A-8B. For example, a user may remove the dip tube 820 from the SCCE 800 after use. As shown in FIG. 8C, the SCCE 800 includes an opening flap 830. The opening flap 830 includes a score 835. For example, the dip tube 820 may insert through the score 835. As shown, the score 835 includes a mating score 840. The SCCE 800 may be configured, for example, to prevent a tube from being withdrawn once operated through the SCCE 800. For example, the opening flap(s) may pinch and/or otherwise engage (e.g., ‘bite into’) the tube to prevent the tube from being withdrawn. In some implementations, for example, the tube may be disposable. When an RDE is decoupled from the can and/or SCCE 800, the tube may be held by the opening flaps and decoupled from the RDE.

In various embodiments, the score 835 may be configured to cut a dip tube when the dip tube is being removed from the SCCE 800. For example, by cutting the dip tube 820, residues (e.g., harmful content) attached to the dip tube 820 may be prevented from exposing. In some implementations, the dip tube 820 may include a rubber diaphragm (not shown). For example, the score 835 and/or the matin score 840 (e.g., configured as a cutting score) may cut the dip tube 820 above the rubber diaphragm. Various shapes of cutting scores may be possible. Some examples are shown as a score 850 and a score 860 as shown in FIGS. 8E-H.

In some embodiments, the scores may be formed into an AICE. The AICE material may, for example, be configured to tear apart at the scores 835, 840, 850, and/or 860 when operated into a dispensing mode (e.g., when a tube is inserted therethrough, when a separate opening mechanism is applied to the can lid). The AICE material may engage the tube when inserted therethrough. In some implementations, a separate material (e.g., foil, polymer) may be coupled to the AICE to form the opening flap(s). Various embodiments may advantageously prevent sharp edge(s) of the scores being exposed.

In some implementations, when an RDE is decoupled, the tube is attempted to be withdrawn from the can through the opening flap(s). As the tube is withdrawn, the flaps (e.g., the opening flap 830, the score 850, the score 860) engage the tube. The flaps may, for example, be progressively urged towards each other as the tube is pulled upwards, thereby progressively engaging (e.g., pinching, cutting) the tube. The tube may, for example, be fully cut through as the flaps meet or approach meeting, thereby re-sealing the SCCE 800. After re-sealed, the SCCE 800 may, for example, advantageously prevent spillage of residual contents (e.g., messy contents, staining contents, toxic contents). Various re-sealing features and mechanisms are described further with reference to FIG. 25.

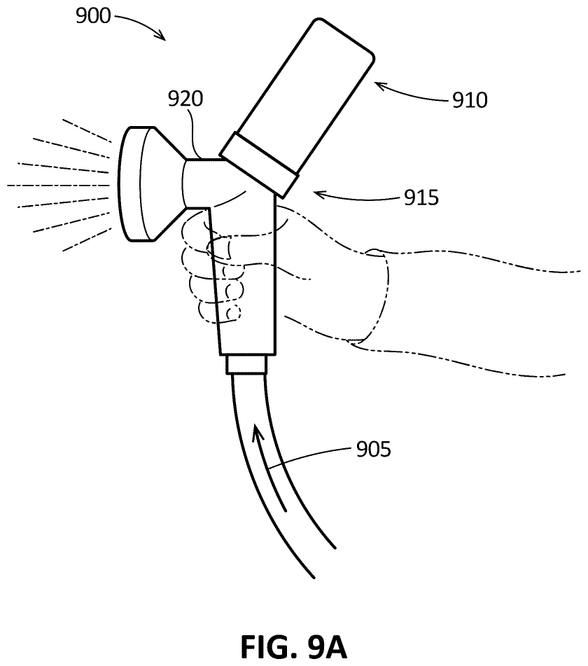

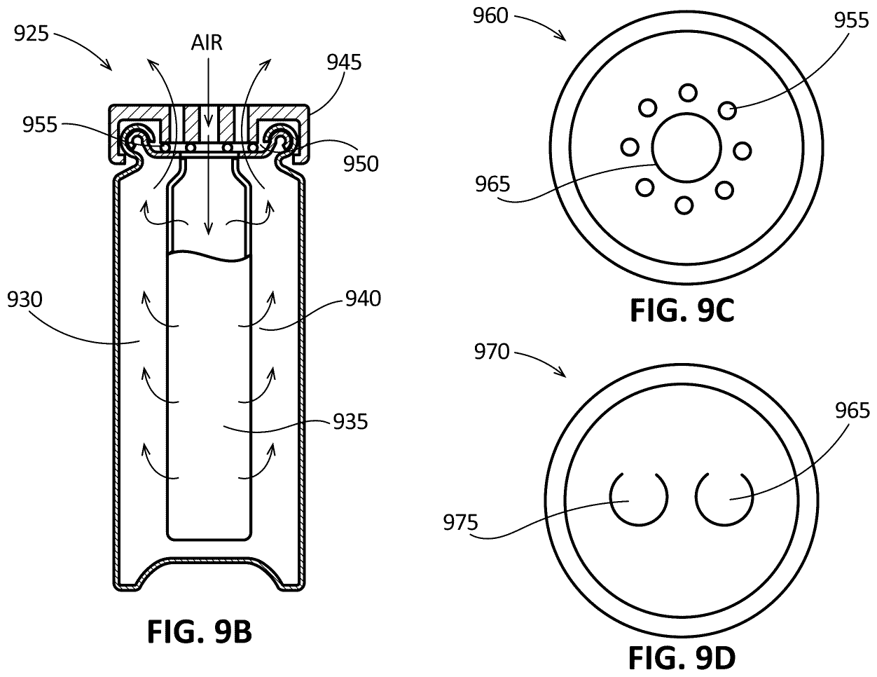

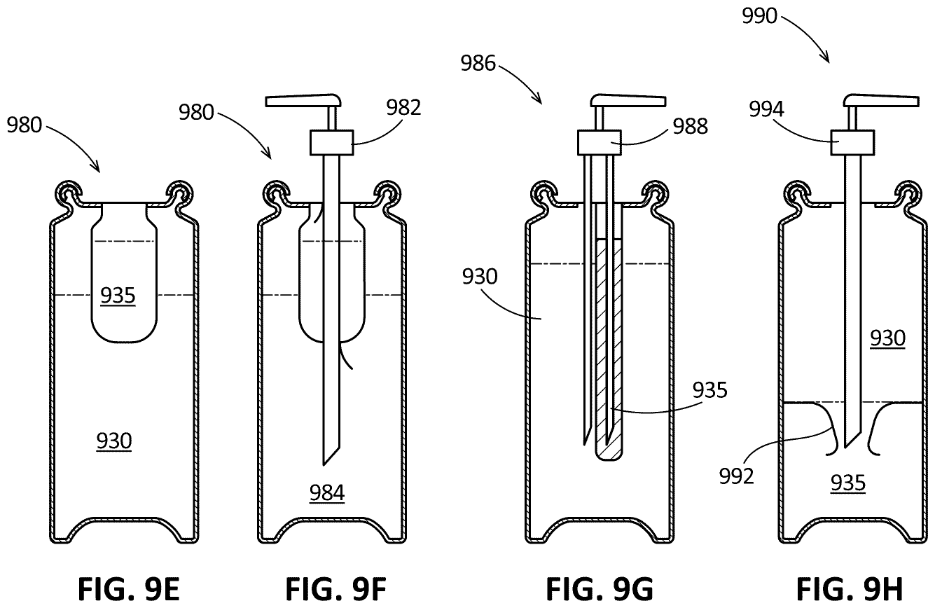

FIG. 9A depicts an exemplary dispensing cartridge employed in an exemplary use case scenario. In this example, a dispenser 900 may include a fluid tube 905 and an applicator cartridge 910. For example, the fluid tube 905 may be connected to a fluid source (e.g., air, water, gas). The applicator cartridge 910 is coupled to the fluid tube 905 at a seam 915. For example, the seam 915 may be coupled to a coupling engine of the dispenser 900. The applicator cartridge 910, for example, may include content to be mixed with the fluid source. For example, the content may include chemicals. For example, the content may include product concentrate. In this example, the dispenser 900 includes a mix chamber 920 to mix the content in a predetermined proportion with the fluid. In some implementations, mixing may be performed in the applicator cartridge 910.

FIG. 9B, FIG. 9C, and FIG. 9D depict an exemplary filter cartridge 925. For example, the exemplary filter cartridge 925 may be coupled to the dispenser 900. In this example, the exemplary filter cartridge 925 includes a first content 930, and a second content 935 contained within a filter media 940. The exemplary filter cartridge 925 includes a manifold 945 coupled to a seam 950. For example, the manifold 945 may include sealing features to sealingly couple to the seam 950. As shown in FIG. 9B, when air is forced into the filter media 940, the second content 935 may be pressured to be mixed with the first content 930. For example, the content mixture may be retrieved from the exemplary filter cartridge 925 via outlets 955.

As shown in FIG. 9C, an AICE 960 includes the outlets 955 and an air aperture 965. For example, air may be forced into the exemplary filter cartridge 925 via the air aperture 965. For example, the content mixture may be retrieved from the outlets 955. Another embodiment of the AICE 970 is shown in FIG. 9D. For example, the air aperture 965 may include only one outlet 975 for the content mixture. For example, the AICE 970 may be configured to allow more viscous content mixture to pass through.

FIG. 9E, FIG. 9F, FIG. 9G, and FIG. 9H depict exemplary embodiments for mixing multiple components in an exemplary dispensing cartridge. As shown in FIG. 9E, a dispensing cartridge 980 may include the first content 930 and the second content 935. In a stowed mode, as shown in FIG. 9E, the first content 930 and the second content 935 are stored in the exemplary dispensing cartridge 980 separated by an impermeable membrane. When a dispenser 982 is inserted into the exemplary dispensing cartridge 980, the impermeable membrane may be broken. As shown, the first content 930 and the second content 935 are therefore mixed to become a mixed content 984.

In another illustrative example, as shown in FIG. 9G, a dispensing cartridge 986 may include the first content 930 and the second content 935. In this example, when a dispenser 988 is inserted into the exemplary dispensing cartridge 986 the first content 930 and the second content 935 are kept separated in a stowed mode. In an active mode, when the dispenser 988 is dispensing, the first content 930 and the second content 935 may be retrieved to be mixed in a mixing chamber of the dispenser 988 before transferred outside.

As shown in FIG. 9H, a dispensing cartridge 990 includes the first content 930 and the second content 935 separated by a membrane 992. When a dispenser 994 is inserted into the dispensing cartridge 990, for example, the membrane 992 may be broken. Then the first content 930 and the second content 935 may be mixed within the dispensing cartridge 990 before dispensed.

FIG. 10A, FIG. 10B, FIG. 10C, FIG. 10D, and FIG. 10E depict exemplary anti-rotation AICEs. As shown in FIG. 10A, an AICE 1000 includes an undercut region 1005. The undercut region 1005 includes a score 1010 and a depressed anti-rotation features 1015. As shown in FIG. 10B, a cross-sectional view of the AICE 1000 is shown. The AICE 1000 further includes a mounting feature 1020. In operation, as shown in FIG. 10C, the AICE 1000 may engage a dispenser 1025. As shown, the dispenser 1025 includes a clip 1030. For example, when the AICE 1000 and the dispenser 1025 are engaged, the mounting feature may engage the depressed anti-rotation features 1015 on one side and the mounting feature 1020 on the other side. For example, the depressed anti-rotation features 1015 and the mounting feature 1020 may securely engage the clip 1030 to advantageously reduce a rotation moment of the dispenser 1025.

As shown in FIGS. 10D-E, an AICE 1035 includes a depressed anti-rotation feature 1040. For example, a coupling engine may securely engage the AICE 1035 by engaging the depressed anti-rotation feature 1040.

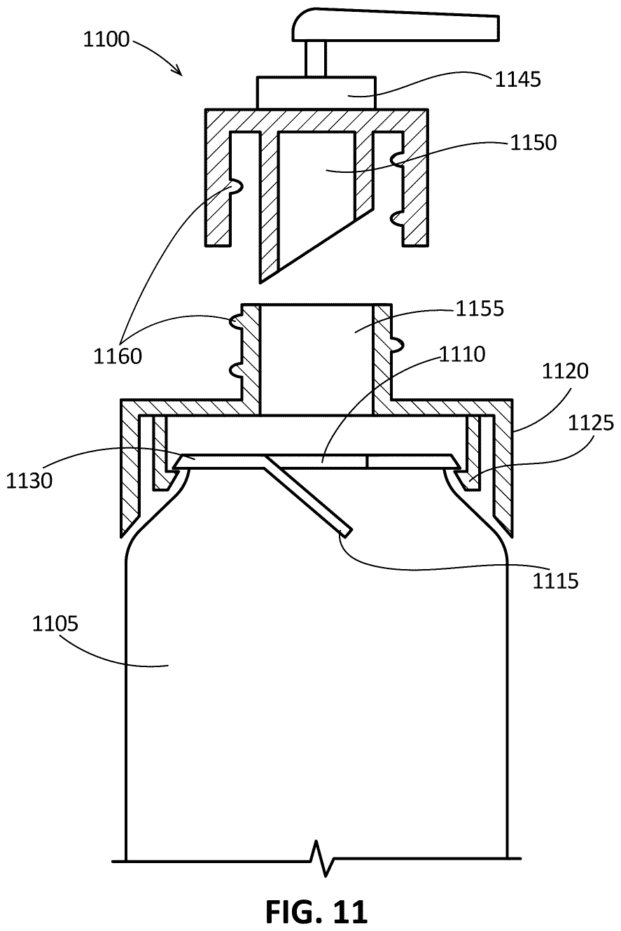

FIG. 11 depicts an exemplary open score AICE. In this example, a dispensing container 1100 includes a can body 1105. For example, the can body 1105 may include product to be dispensed. The can body 1105 includes a score 1110. In this example, the score 1110 includes a flap 1115 (e.g., the opening flap 830).

The can body 1105 is coupled to a coupling engine 1120. As shown, the coupling engine 1120 includes a clip 1125 to securely engage with a seam 1130 of the can body 1105. For example, the seam 1130 may be an outer rim of the can end. As shown, in engagement mode, a dispenser 1145 may engage with the flap 1115 through the coupling engine 1120. For example, the dispenser 1145 may be in fluid communication with a pump. For example, the dispenser 1145 may not be coupled to a pump. As shown, the dispenser 1145 may be configured to threadedly engage the coupling engine 1120 via the threads 1160.

In this example, the dispenser 1145 includes a punch 1150. As shown, the coupling engine 1120 includes a lumen 1155 configured to allow the punch 1150 to pass through (e.g., traverse through) and engage the (closed) flap 1115. For example, the punch 1150 may be operated to break open the flap 1115 to establish fluid communication between the can body 1105 and the dispenser 1145.

In various implementations, a dispensing body may include an upper body (e.g., the dispenser 1145) and a lower body (e.g., the coupling engine 1120). For example, the lower body may include a clip (e.g., the clip 1125) configured to engage an outer rim (e.g., the seam 1130) of the can end. For example, the lower body may also include a lumen 1155 configured to allow a punch module (e.g., the punch 1150) of the upper body to pass through and to engage the can end and the clip mitigate a rotational force induced by threadedly engaging of the upper body and the lower body.

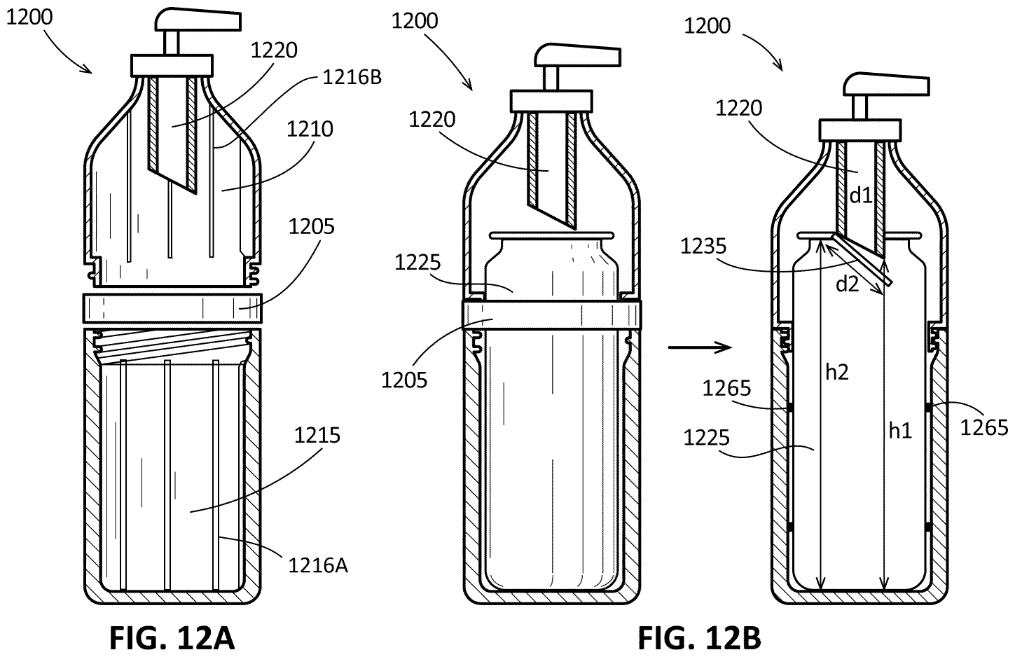

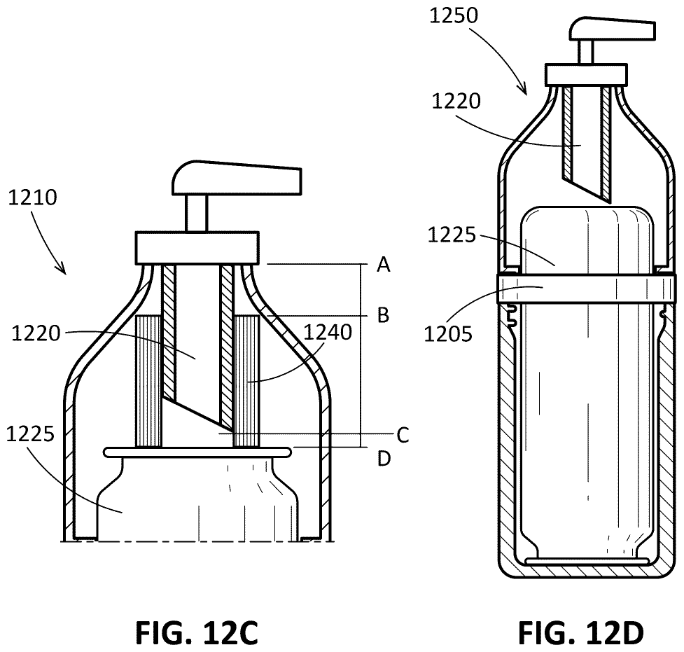

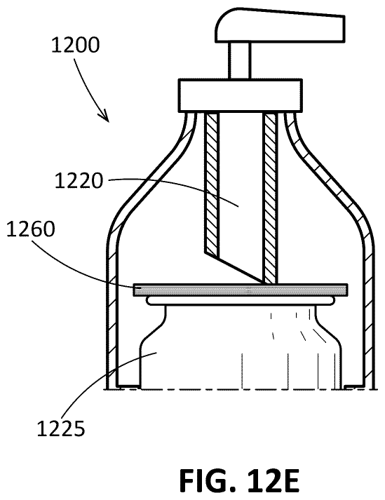

FIG. 12A and FIG. 12B depict an exemplary dispenser spacer. In this example, a dispensing container 1200 includes a spacer 1205 between a top case 1210 and a bottom case 1215. As shown in FIG. 12A, the dispensing container 1200 further includes a punch 1220. In some examples, as illustrated with reference to FIG. 12B, the dispensing container 1200 may include a can body 1225. For example, the dispensing container 1200 may be assembled in a stowed mode of the dispensing container 1200 (e.g., for transportation, displaying on shelf). The spacer 1205 may advantageously avoid the punch 1220 from prematurely contacting the can body 1225. In an operation mode, the spacer 1205 is removed. After the spacer 1205 is removed, as shown, the top case 1210 is configured to couple to the bottom case 1215. For example, the punch 1220 may break open an open flap 1235 of the can body 1225.

As shown in FIG. 12B, the dispensing container 1200 includes height h1 from a bottom end of the punch 1220 to the bottom of the dispensing container 1200. The can body 1225 includes a height of h2. For the punch 1220 to break open the can body 1225, h2>h1. For example, the spacer 1205 may include a separation height h3, such that h3>h2−h1. For example, in the stowed mode, the punch 1220 may be prevented from engaging the can body 1225 by the spacer 1205.

In some implementations, the punch 1220 may include specific heights for punching open different products. For example, a punch designed for opening a toxic product container may be longer than a punch designed for opening a non-toxic product (e.g., body lotion) container. Therefore, h1_toxic<h1_non-toxic.

For example, when a can is designed to carry a toxic product, the can body 1225 may be shorter than a can body carrying non-toxic product (e.g., body lotion) such that h2_toxic<h2_non-toxic. For example, when a user tries to punch open a toxic can with a non-toxic dispenser, due to h2_toxic<h1_non-toxic. For example, the shortened height of the can body with toxic product h2_toxic and/or the longer punch length for toxic product may advantageously avoid accidental opening of the toxic carrier by a dispenser for non-toxic use, and thereby advantageously improve user safety.

As shown, the punch 1220 includes a diameter d1. The can body includes a score diameter d2. In some implementations, a can body containing a toxic product may include a larger score diameter than a can body containing a non-toxic product such that d2>d1. For example, when d2>d1, the can body carrying toxic product may advantageously be prevented from being broken open by the punch of a non-toxic product.

In this example, the bottom case 1215 may include protrusions 1265 and/or protrusions 1216A. For example, the protrusions may extend towards an internal cavity of the lower body. For example, the protrusions 1265 may guide the can body 1225 to be aligned at the center of the internal cavity defined by the bottom case 1215. In some implementations, the alignment may advantageously help to align the punch 1220 and the open flap 1235.

In some implementations, the top case 1210 may include protrusions 1216B extending towards an internal cavity of the upper body. For example, the protrusions may guide the can body 1225 to be aligned at the center of the internal cavity defined by the top case 1210. In some implementations, the alignment may advantageously help to align the punch 1220 and the open flap 1235.

FIG. 12C depicts an exemplary internal spacer tube. In this example, the top case 1210 may include a spacer tube 1240. For example, the spacer tube 1240 may be made of plastic. For example, the spacer tube 1240 may be made of metal. For example, the spacer tube 1240 may be made of a recyclable material (e.g., paper, bamboo). For example, the spacer tube 1240 may be rigid.

As shown, the spacer tube 1240 may be disposed to wrap around the punch 1220. In the stowed mode, for example, the punch 1220 may be inserted through a lumen of the spacer tube 1240. For example, the spacer tube 1240 may engage a point B at a neck of the top case 1210 at one end and a top surface D of the can body 1225. For example, the neck may be a point of a wall of the top case 1210. In this example, the punch 1220 may include a length as indicated by a distance between point A and point C. For example, the distance BD (the spacer length) may be larger than a distance BC so that the punch 1220 is prevented from contacting a predetermined opening of the can body 1225. In some examples, in a stowed mode, the spacer tube 1240 may be installed such that the can body 1225 is prevented from being accidentally opened during, for example, transportation. In some implementations, the dispensing container 1200 may be transported without the spacer 1205 without reducing a strength to resist a downward force from the punch 1220. For example, in the operation mode, the spacer tube 1240 may be removed to allow the punch 1220 to engage a can end of the can body 1225.

FIG. 12D depicts an exemplary transportation arrangement 1250 using the exemplary dispenser spacer described with reference to FIGS. 12A-B. In this example, the can body 1225 is placed upside down in a stowed mode. For example, because a bottom surface of the can body 1225 does not have a predetermined opening (e.g., for making the open flap 1235), the bottom surface may advantageously withstand a higher pressure from the punch 1220 without breaking. For example, the transportation arrangement 1250 may advantageously reduce a chance of the can body 1225 being broken open accidentally during transportation.

FIG. 12E depicts an exemplary removable shield disposed between a punch module and the can end. In this example, a removable shield 1260 may span at least across an upper surface of the can body 1225. For example, the removable shield 1260 may span a cross section of the top case 1210. For example, the removable shield 1260 may have an area equal to a surface area of the top surface of the can body 1225. For example, the removable shield 1260 may, in the stow mode, prevent the punch 1220 from breaking a top surface of the can body 1225.

In various implementations, a dispensing body may include a spacer module (e.g., the spacer 1205), an upper body (e.g., top case 1210) having a punch member (e.g., the punch 1220), and a lower body (e.g., the bottom case 1215). For example, in a stowed mode, the upper body and the lower body are separated by the spacer module. For example, the dispensing body may entirely encapsulate a container without engaging a can end of the container. For example, in an operation mode, the spacer module may be removed such that the upper and lower body are coupled directly together. For example, the punch member may then engage the can end to break open a score of the can end. For example, in the stowed mode, the container may be stored within the upper body and the lower body upside down. In some implementations, the upper body may, in the stowed mode, include a removable shield disposed between a punch module and the can end. For example, the removable shield spans at least across an upper surface of the can end. In some implementations, the lower body may include protrusions (e.g., the protrusions 1265). For example, the protrusions may extend towards an internal cavity of the lower body.

FIG. 13A, FIG. 13B, and FIG. 13C depicts an exemplary top component of a container having a hammer element. In this example, a top component 1300 may include threads 1305 and a hammer element 1310. For example, the top component 1300 may be used to sealingly connect a dispenser to a container (e.g., the container 500, the container 600, the can body 1225). For example, a user may threadedly couple the top component 1300 to the AICE 100 having a score (e.g., the score 205). For example, the threads 1305 and the hammer element 1310 may advantageously enable opening of the container with ease.

In some implementations, the hammer element 1310 may be designed with a predetermined length. For example, if the predetermined length is too short, the AICE 100 may flex, reducing an efficiency of penetrating the AICE 100 (e.g., through the score 2135). In some examples, if the predetermined length is too long, a downward force may be dispersed and reduce the efficiency of penetrating the AICE 100.

FIG. 13B and FIG. 13C depicts an illustrative embodiment of a hammer module. For example, a hammer module 1315 may be inserted into a dispensing module (e.g., a reusable dispensing engine such as disclosed at least with reference to FIGS. 1-16, 25-27B of U.S. Provisional Application Ser. No. 63/387,250, titled “Recyclable Container Modular Dispensing System,” filed by Nicholas Guy Paget, et al., on Dec. 13, 2022; and/or FIGS. 1B-1D, 3-4, 5C, 5E, 6A-17D.

For example, the hammer module 1315 may be provided (e.g., releasably, assembled, machined into, molded into, adhered into, coupled into) in a dispensing engine. The hammer element 1310 may, for example, have a ramp 1330, as depicted. The hammer element 1310 may, for example, have a ramp 1325, as depicted. In some implementations, for example, one ramp (e.g., the ramp 1330) may be designed to gradually engage the surface of the can as the hammer module 1315 is advanced towards a can end (e.g., along a longitudinal axis of the can). In some implementations, for example, one ramp (e.g., the ramp 1325) may be designed to provide a ‘relief cut’ to induce a local elevation in difference between stress concentrations (e.g., at a transition point between the ramp 1330 and the ramp 1325), such as, for example, to induce tearing at the score based on a stress concentration distribution at the score and the parent materials. In some implementations, the ramp 1330 may include a steep angle to advantageously guarantee that a breaking force is always at an extreme end. For example, if the ramp 1330 does not have an adequate angle, for example, the top component 1300 may deform without breaking.

As depicted, the hammer module 1315 includes a lumen 1320 connecting at least two apertures (e.g., at opposing ends of the hammer module 1315, as depicted). For example, the lumen 1320 may allow a dispensing device (e.g., pump) to be operated into fluid communication with an inside of a can via the lumen 1320 (e.g., by sealingly fluidly coupling to an aperture of the lumen 1320, by inserting a straw through the lumen 1320). Illustrative dimensions are depicted for this particular embodiment. Some embodiments may include the same or differing measurements.

In various implementations, a punch member (e.g., the hammer module 1315) may include a tooth module (e.g., the hammer element 1310) having a first ramp (e.g., the ramp 1330) and a second ramp (e.g., the ramp 1325). For example, the first ramp may be configured to have a steeper slope than the second ramp to gradually engage an engagement surface of the can end. For example, the second ramp includes a gentler slope to provide a ‘relief cut’ to induce a local elevation in difference between stress concentrations.

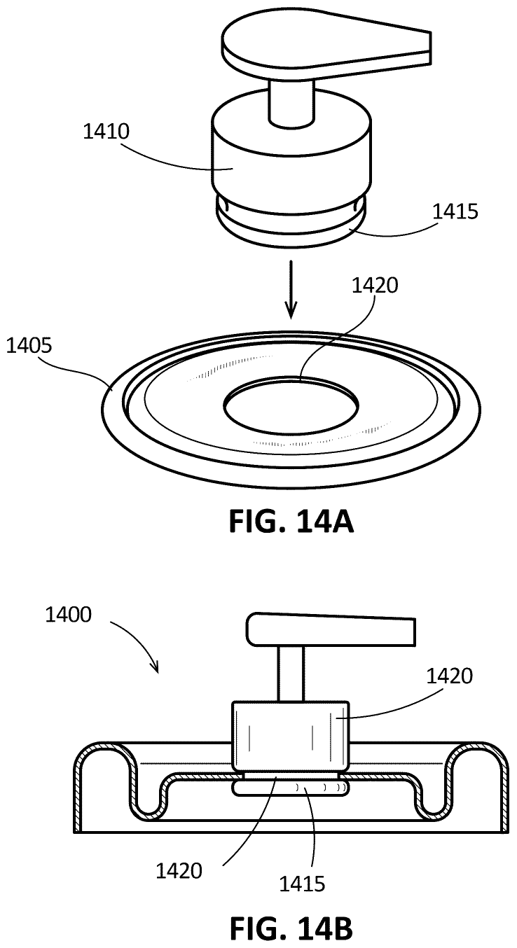

FIG. 14A and FIG. 14B depict an exemplary dispensing engine having an exemplary retaining pump flange. FIG. 14A is an assembly diagram showing an assembly 1400 including an AICE 1405 and a dispenser 1410. As shown, the dispenser 1410 is inserted into the AICE 1405 by coupling a pump flange 1415 and an open score 1420. As shown in FIG. 14B, the dispenser 1410 is retained by an edge of the open score 1420 engaging the pump flange 1415.

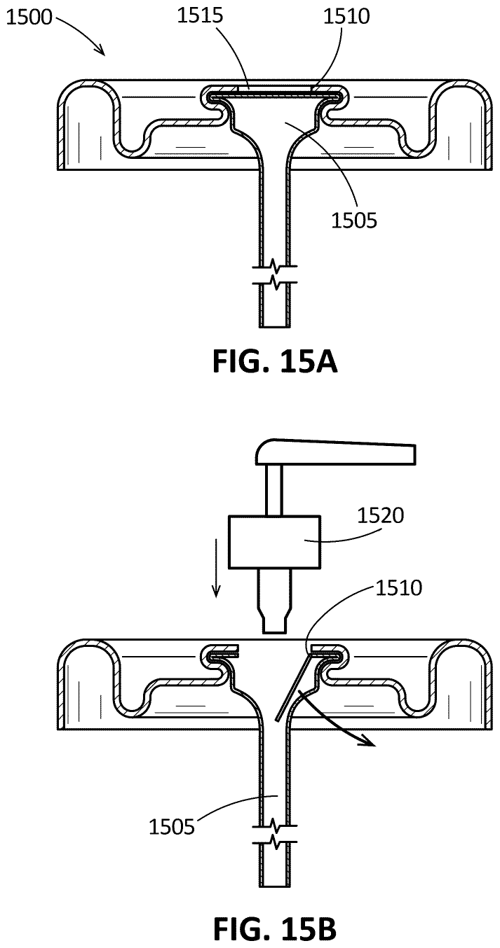

FIG. 15A and FIG. 15B depict an exemplary AICE without a ball valve. As shown in FIG. 15A, an AICE 1500 includes a retained flanged tube 1505. The retained flanged tube 1505 is securely retained by a score 1515. The score 1515 includes a score hinge 1510 to prevent internal content from being exposed. In various implementations, the retained flanged tube 1505 may be pre-assembled to the AICE 1500. In various implementations, the retained flanged tube 1505 may be molded to the AICE 1500 as a single piece.

In an assembly mode, as shown in FIG. 15B, a dispenser 1520 is inserted through the score 1515. For example, the dispenser 1520 may push open the score hinge 1510 to form fluid communication inside the AICE 1500. The AICE 1500 may advantageously be manufactured without a ball valve. For example, the AICE 1500 may reduce pressure within and advantageously prevent accidental decoupling of the dispenser 1520 due to excessive pressure.

In various implementations, the AICE 1500 may be configured to maintain fluid seal (e.g., gas seal) during pressurized and depressurized operations. For example, when the dispenser 1520 is dispensing a fluid (by pressurizing and depressurizing a container covered by the AICE 1500), the AICE 1500 may advantageously keep gas (e.g., ambient air) from entering the container.

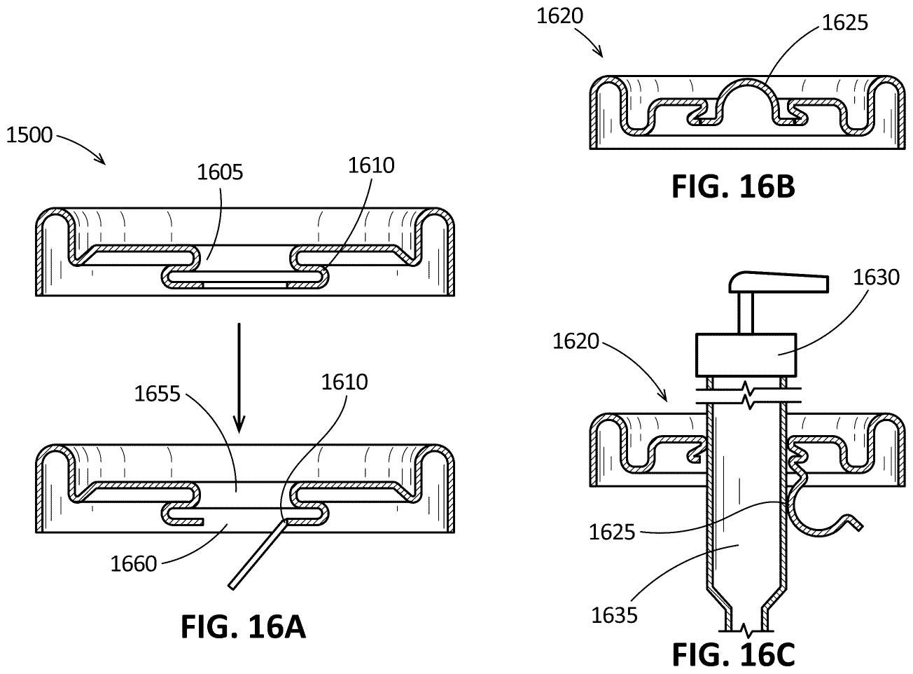

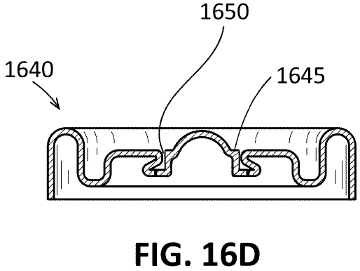

FIG. 16A depicts an exemplary AICE having an exemplary safety edge. An AICE 1600 includes a safety edge 1605 and a score 1615. For example, the safety edge 1605 may be a rolling edge. The score is coupled to the AICE 1600 at a score hinge 1610. For example, when a dispenser (e.g., a pump, a dip tube) is inserted through the score 1615, the score hinge 1610 may be forced open. For example, the score hinge 1610 may prevent internal content from being exposed (e.g., evaporated, spilled) to an external environment.

For example, the AICE 1600 may define a first aperture 1655 by the safety edge 1605. For example, a second aperture 1660 may be a predetermined aperture defined by opening along the score 1615. For example, the first aperture 1655 may be disposed outward of the second aperture 1660 when the can end is coupled to a container as described below with reference to FIG. 16C

FIG. 16B and FIG. 16C depict a second embodiment of an exemplary AICE having an exemplary safety edge. An AICE 1620 includes a bump 1625. When a dispenser 1630 is inserted into the AICE 1620, as shown in FIG. 16C, a dip tube 1635 of the dispenser 1630 may move the bump 1625. For example, the bump 1625 may advantageously prevent an edge of the bump from catching on the dip tube 1635.

FIG. 16D depicts an exemplary AICE 1640 having a bump extension 1645. For example, the bump extension 1645 may advantageously prevent dust deposition into a groove 1650. In some examples, a user may simply swipe on top of the AICE 1640 before inserting the dispenser 1630 to prevent excess dust contaminating content within the AICE 1640. The bump extension is formed with a shoulder (pointed to by the lead line for the bump extension 1645). The shoulder may, for example, receive a pressing force (e.g., by an RDE). Force applied to the shoulder may be transferred to the score. For example, in some implementations, the shoulder may touch the upper panel surface such that the groove 1650 is substantially (e.g., visibly) occluded (e.g., unable to see into the groove). In some implementations, the shoulder may be formed pressed against the upper panel.

In some implementations, an opening tab of a can end may include a curved bump (e.g., the bump 1625). For example, when the dispensing body (e.g., the dispenser 1630) engaged the can end (e.g., the AICE 1500) and a dip tube (e.g., the dip tube 1635) is inserted into the container, the opening tab may contact the dip tube at the curved bump and not at an edge of the opening tab or hinge.

FIG. 17A and FIG. 17B depict an exemplary AICE having a depressed engagement area.an AICE 1700 includes a depressed area 1705 connected to the AICE 1700 via a hinge 1710. For example, the depressed area 1705 may be located proximally to the hinge 1710. The AICE 1700 also includes a score 1715 configured to allow a dispenser (e.g., a dip tube) to be inserted through the AICE 1700. As shown in FIG. 17B, a punch 1720 is engaging the score 1715. In some implementations, the score 1715 may be open at the hinge 1710. For example, the depressed area 1705 may advantageously prevent the inserted dispenser from contacting the hinge 1710.

FIG. 17C and FIG. 17D depict an exemplary AICE having a raised engagement area. As shown, an AICE 1725 includes a raised area 1730. For example, the raised area 1730 may be located distally to the hinge 1710. As shown in FIG. 17D, a punch 1720 is engaging the score 1715. In some implementations, the score 1715 may be open at the hinge 1710. For example, the raised area 1730 may advantageously prevent the inserted dispenser from contacting the hinge 1710.

Although an example of a system, which may be portable, has been described with reference to the above figures, other implementations may be deployed in other processing applications, such as desktop and networked environments.

FIG. 18A shows an exemplary pattern topping module. For example, a pattern topping module may be configured to create a lobed and/or “daisy-appearance” seam at a container. In this example, a pattern topping module 1800 includes a daisy topping engine 1805. As shown, a container 1810 is securely held by a frame 1815 of the pattern topping module 1800 against the daisy topping engine 1805. For example, a can top of the container may be malleable. For example, the daisy topping engine 1805 may be operated to create a daisy-appearance seam at the container 1810.

FIG. 18B shows a top-down cross-section view of an exemplary daisy topping engine 1805. As shown, the daisy topping engine 1805 includes multiple digits 1820 concentrically arranged towards a center plate 1825. In some implementations, the container 1810 may be securely pressed against the center plate 1825 by the frame 1815. As shown in a closed up diagram in FIG. 18B, each of the multiple digits 1820 includes a patterned tip 1830. For example, in operations, the multiple digits 1820 may move radially inwards towards the container 1810 placed on the center plate 1825. A can top of the container 1810 may be operated to create a shape defined by the patterned tip 1830.

In various implementations, the container (e.g., the container 1810) may be made of metal. For example, the container 1810 may include a complete metallic envelope including the can top. Air diffusion, for example, may advantageously be reduced. For example, a container with a complete metallic envelope may advantageously be used to carry products requiring an air barrier.

In some implementations, the pattern topping module 1800 may include a lettering module. For example, the lettering module may be configured to engrave letters to the container 1810. For example, the lettering module may advantageously engrave warnings (e.g., “DO NOT DRINK”) onto the container 1810. For example, the lettering module may advantageously engrave marketing materials (e.g., a logo, a brand name, a trade name) onto the container 1810.

FIG. 18C depicts an illustrative patterned can seam. As shown, an AICE 1840 is seamed to a can body to create a seam 1845. A pattern 1850 is formed into the seam 1845. The pattern 1850 may, for example, be formed during sealing of the AICE 1840 to the can body. In some implementations, the pattern 1850 may be formed in another operation (e.g., after forming the seam 1845). In the depicted example, the pattern 1850 is formed as text. The pattern 1850 may include various visual indicia (e.g., text, patterns, images, icons). The visual indicia may, for example, include safety and/or warning contents (e.g., toxic chemical, do not drink, use only as directed). The visual indicia may, for example, include marketing messages (e.g., branding, advantages, features). The visual indicia may, for example, include informational content (e.g., attach here, insert this end up, compatible with model number . . . ).

FIG. 19A and FIG. 19B depict an exemplary 360-degree score design of an exemplary AICE having a predetermined hinge. In this example, a top surface 1900 of an AICE (e.g., the AICE 100) includes a 360° score 1905. For example, the 360° score 1905 may be disposed on the top surface 1900 in 360°. As shown, the 360° score 1905 includes a hinge region 1910. For example, at a top view, a user may find the hinge region 1910 invisible because of the 360° score 1905.

A cross-section along the line 19B-19B is shown in FIG. 19B. As shown, the top surface 1900 may include an AICE thickness of about th_end thick (e.g., 0.1 mm). In some implementations, the hinge region 1910 may include a depth of d_hinge, and the hinge region 1910 may include a depth of d_score. For example, d_hinge<d_score<th_end. As an illustrative example without limitation, the score 1905 may be 0.1 mm deep except the hinge region 1910 may be 0.005 mm deep. For example, the score 1905 and the hinge region 1910 may provide a visual impression of a full circle score before the score 1905 is broken open.

In various implementations, when a dispenser is punched through the score 1905, regions other than the hinge region 1910 may be punched through before the hinge region 1910. For example, the hinge region 1910 may remain intact (e.g., hanging on to the top surface 1900) when the score 1905 is punched open, forming a hinge of the score 1905.

FIG. 20A, FIG. 20B, and FIG. 20C depict an exemplary 360-degree score design of an exemplary AICE having predetermined check slots. In this example, an AICE 2000 includes a check slot 2005a and a check slot 2005b. As shown, the check slot 2005a may include a length of L1 and the check slot 2005b may include a length of L2. For example, L1 may be equal to L2. In some examples, L2 and L1 are not the same. In various examples, the AICE 2000 may include only one check slot. In some examples, the AICE 2000 may include more than two (e.g., 3, 4, 6) check slots. In some embodiments, the check slot 2005a and check slot 2005b may be evenly distributed along a score 2010. For example, when the score 2010 is broken by a punch, the score 2010 may become an open tab (e.g., the open flap 1235) hinged at one of the check slots 2005a, 2005b. In some implementations, the check slot 2005a and check slot 2005b may be separated by a predetermined angular position. For example, an angular distance between two closest edge of the check slot 2005a and the check slot 2005b at ρ_(a−b) may be at least 90°, where the angular position is measured from a center of the score 2010.

In some implementations, check slot lengths (L1, L2) may, for example, be between 0.24″ and 0.26″. The check slot lengths may, for example, be set from the energy parameters that are measured during an (experimental) opening process. The determined check slot length (e.g., 0.24″ inch) may, for example, advantageously ensure that, independent of an initial engagement point of a hammer module at the AICE 2000, the first anticipated check slot does not break when the score line pops (e.g., directly on) to the first anticipated check slot.

For example, at shorter lengths, a required kinetic force and energy for breaking through a check slot is reduced. The breaking of all check slots may, for example, cause an open tab (e.g., the open flap 1235) to detach from an aperture of the AICE 2000. As an illustrative example, with the two check slots 2005a, 2005b, the check slot 2005a may be broken due to a downward force of a punch. For example, a check slot length of the check slot 2005b greater than 0.26″ may advantageously provide more difficulty to punch through the second check slot 2005b.

As shown in a cross-section diagram depicted in FIG. 20B, the check slot 2005b may include a check slot residual D1. As shown in a cross-section diagram depicted in FIG. 20C, the score 2010 may include a score residual D2.

The check slot residual D1 may, for example, be set between 0.0054″ & 0.0060″. The low specification (0.0054″) may be determined based on a need for adequate resistance to the energy created from a pop force from the punch. The check slot (e.g., the check slot 2005a, the check slot 2005b) may, for example, allow for the AICE 2000 to remain coupled to the aperture. The high specification limit (0.0060″) of the check slot residual may, for example, be determined relative to the maximum force required to shear the score 2010 without shearing into a parent material 2020 of the AICE 2000.

In various implementations, a score of a can end (e.g., the score 2010) may include a check slot (e.g., 1, 2, more than two check slots). For example, each of the check slots may include at least 25% thicker profile (e.g., 0.0054-0.0060 in vs 0. 0.0037-0.0040 in) than the rest of the score. For example, an open tab (e.g., the open flap 1235) may be attached to the can end upon opening without cutting into a parental material of the can end.

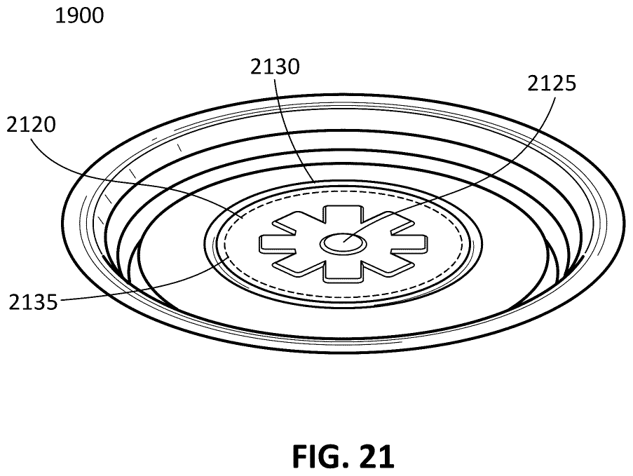

FIG. 21 depicts an exemplary AICE having a sunken center panel, a 360-degree score, and an invisible hinge. Various embodiments of the top surface 1900 may include slack metal (e.g., a patterned region with a raised/depressed level) at the center of the top surface 1900. In this example, the top surface 1900 includes a depressed panel 2120 and a center bump 2125. The depressed panel 2120, for example, may include slack material that may absorb excess materials when the top surface 1900 is formed (e.g., prior to sealing an AICE to a can body) and/or pierced open (e.g., after the AICE and can body are seamed together). In some implementations, for example, the center bump 2125 may advantageously provide a preventive visual optics to visually prevent a user from piercing the top surface 1900 and/or the center bump 2125 with a straw.

In various implementations, the top surface 1900 may include multiple levels of depressed and/or raised levels. For example, various levels may further include aesthetic elements. In some examples, some levels may include further visual aid elements for aiding a user to use the container.

The top surface 1900 also includes an outer chamfered edge 2130. The outer chamfered edge 2130 includes a score 2135. For example, a user may fluidly connect a dispenser to the container via the score 2135. In this example, the score 2135 may be a 360° score. In some embodiments, the score 2135 may be a less than 360° score (e.g., a score that does not go around a full circle). For example, a less than 360° score may provide a strong connection at a hinge when the depressed panel 2120 is pushed open. In some implementations, having a 360° score, the score 2135 may be advantageously invisible.

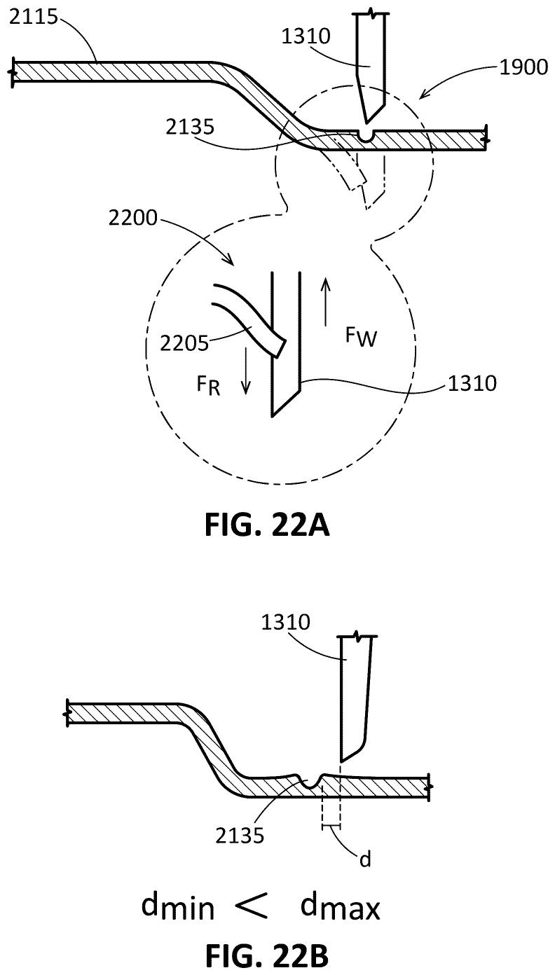

FIG. 22A and FIG. 22B depict exemplary score opening mechanisms using exemplary hammer elements, for example, as described with reference to FIGS. 13A-C. As shown in FIG. 22A, the hammer element 1310 is configured to penetrate the top surface 1900 at the score 2135. In some implementations, after the hammer element 1310 pierced through the score 2135, a cut edge 2205 of the AICE 100 may dig into the hammer element 1310 (as shown in a force diagram 2200 shown in FIG. 22A). For example, when a container (e.g., the container 500) is to be replaced and the top component 1300 (e.g., the pump 535) is to be removed from the container, the cut edge 2205 of the top surface 1900 may exert a retaining force (F_R) opposing to a withdrawing force (F_W). For example, a user may find it difficult to remove the top component 1300 from the used container.

As shown in FIG. 22B, the hammer element 1310 (e.g., an opening element, a dispenser element) is configured to pierce through the AICE 100 at a distance d from the score 2135. In some implementations, the top component 1300 may be designed that a radius of the hammer element 1310 is less than a radius of the score 2135 by d. For example, the radius of the hammer element 1310 may be adjusted to advantageously prevent the cut edge 2205 from digging into the hammer element 1310. For example, the adjustment may be configured to be between a minimum distance (d_min) and a maximum distance (d_max). For example, the d_min may be a minimum distance to avoid the cut edge 2205 to be contacting the hammer element 1310. For example, the d_max may be the maximum distance where the hammer element 1310 may penetrate the score 2135 with a predetermined maximum force.

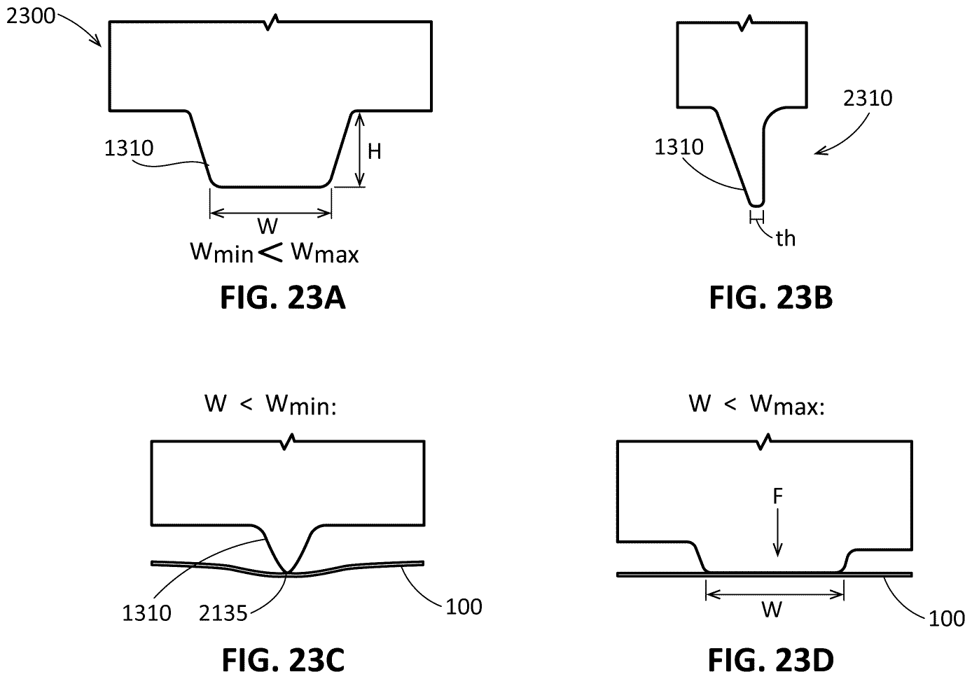

FIG. 23A, FIG. 23B, FIG. 23C, and FIG. 23D depict exemplary design considerations of the hammer element described with reference to FIGS. 13A-C. In some implementations, a shape of the hammer element 1310 may be configured to maintain a minimum opening pressure to advantageously prevent bursting when, for example, the top component 1300 is coupled to a reusable container having the top surface 1900. In some implementations, the radius of the hammer element 1310 may be adjusted in units of micrometers. In some implementations, the radius of the hammer element 1310 may be adjusted in units of nanometers.

As shown in FIG. 23A, a side view 2300 of the hammer element 1310 may include a width w and maximum height H. As shown in FIG. 23B, a side view 2310 orthogonal to the side view 2300 of the hammer element 1310 may include a thickness th. For example, in an operation to couple the top component 1300 to a container, a downward pressure may be exerted on the top surface 1900 directly proportional to w and th. In various implementations, w may be configured to be between a predetermined minimum width (w_min) and a predetermined maximum width (w_max). For example, the w_min and the w_max may be determined based on a material of the AICE 100, a structure of the score 2135, the material of the hammer element 1310, or a combination thereof.

In some implementations, the hammer element 1310 may be designed with a predetermined target force to open the top surface 1900 of an AICE. For example, F_target may be designed to be not too great to advantageously allow a user to open the top surface 1900 with ease. As shown in FIG. 23C, w<w_min. For example, the AICE 100 may flex downward to redirect energy from (breaking) the score 2135. In some examples, the force may be too great resulting in breaking the top surface 1900.

As shown in FIG. 23D, w>w_max. In this example, a force (F) is used to penetrate open the AICE 100. Because pressure (P) is force divided by area (F/A) and an area increases with width, for example, a force required (F_required) to create a pressure to open the container may be greater than the predetermined target force.

In some implementations, the hammer module 1315 may be deformed while it is breaking through the AICE 100. For example, an end of the hammer module 1315 may be deformed upwards. In some examples, the maximum height H may be determined such that it is long to advantageously allow the surface width w of the hammer module 1315 to contact the AICE 100 and maintain a breaking force. For example, H may be at least 4 mm for a 202 can end.

In some implementations, a can-end (e.g., the AICE 100) may include an offset between a score line (e.g., the score 2135) and a depressed panel radius (e.g., the depressed panel 2120). For example, a 0.080″ offset may reduce a required opening force by 20%.

As an illustrative example, two hammer elements may be tested. For example, an original tooth may be a hammer element with a surface area of 0.3643 inches\hat{ }2. For example, a reduced tooth may be a hammer element with a surface area of 0.0039 inches\hat{ }2. For example, a decreased surface area (with the reduced tooth) may reduce a required force to open a can-end. In some implementations, the reduced tooth may reduce the required force by around 50%. For example, a 0.010″-0.030″ inboard from a score line may provide a 20% reduction in the required opening force. In various implementations, an offset (e.g., an offset of 0.0023″ to an offset of 0.0037 inches) may be determined based on safety requirements and/or targeted user's opening and pressure capabilities. For example, a larger force may be required if the container is storing a safety critical content (e.g., toxic gas). For example, a smaller force may be required if the container is designed for elderly or weakened patients at a hospital.

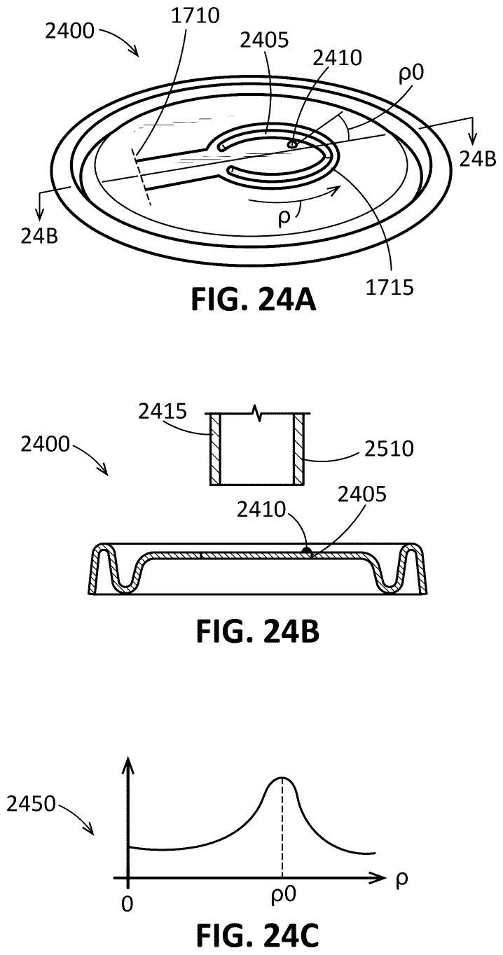

FIG. 24A, FIG. 24B, and FIG. 24C depicts an exemplary reusable dispenser system having a flat punch element. In this example, an AICE 2400 includes the hinge 1710 and a score 2405. For example, the score 2405 may be a 360° score.

In this example, the AICE 2400 includes a protrusion 2410 located interior to the score 2405. For example, the protrusion 2410 may be extending upward from a top surface of the AICE 2400. In some implementations, the score 2405 may include more than one protrusions. In this example, the protrusion 2410 may be disposed at an angle ρ_0. As shown in a cross section diagram in FIG. 24B, when a flat hammer module 2415 advances against the AICE 2400, a pressure (σ) may be induced at the protrusion 2410. For example, kinetic energy may be concentrated at the protrusion 2410. Because pressure is Force divided by Area, for example, the pressure at the protrusion 2410 with a small surface area may induce a bigger pressure than other parts of the score 2405 (as shown in an exemplary pressure-angular position graph 2450 in FIG. 24C). For example, the protrusion 2410 may advantageously allow a flat pump to break the score 2405 with a predetermined force less than a force required to break the score 2405 without the protrusion 2410.

FIG. 25 depicts an exemplary sealing module coupled to a punch module of an exemplary reusable dispenser. In this example, a reusable dispensing system 2500 includes a dispensing module 2505 coupled to a can body 2510. As shown, the dispensing module 2505 engaged with an AICE 2515 with a punch module 2520. For example, the punch module 2520 may be configured to break through a score of the AICE 2515.

In this example, the dispensing module 2505 includes a tubular seal 2525 around the punch module 2520. For example, the tubular seal 2525 may include a triangular profile 2530 near a distal end of the punch module 2520. The tubular seal 2525 may, for example, be configured (e.g., pre-shaped) to ‘flare outward’ (e.g., radially outward from a central longitudinal axis of the punch module 2520). The flare may, for example, be configured to form a ‘triangular profile’ 2530 as shown. For example, the tubular seal 2525 may be flexible. In some implementations, the flare (e.g., triangular profile 2530) may open up and seal against a top surface of the AICE 2515. For example, the triangular profile 2530 may flex outwardly along a horizontal plane of an upper surface 2535 of the AICE 2515 after the dispensing module 2505 is coupled to the AICE 2515.

In some examples, such as depicted, a distal end of the tubular seal 2525 (e.g., the triangular profile 2530) may seal against a vertically displaced surface 2540 of the AICE 2515. In some implementations (e.g., as shown), the vertically displaced surface 2540 may, for example, be configured such as disclosed at least with reference to FIGS. 1A-1D, 3-4, and 20A-22B.

In various examples, the shape and/or engagement with the AICE 2515 of the distal end of the tubular seal 2525 (e.g., of the triangular profile 2530) may advantageously prevent the tubular seal 2525 from dislocation, dislodgement, and/or unsealing (e.g., from rolling around and/or sliding offset from the aperture) from the top surface of the AICE 2515. For example, the triangular profile 2530 may include a predetermined height configured to stop the seal 2525 (e.g., triangular profile 2530) from opening up and lose contact with the AICE 2515. For example, the engagement portion of the seal 2525 (e.g., a flared and/or flareable portion, such as triangular profile 2530) may include a height to thickness ratio of at least 2:1 to 3:1.

In some implementations, the AICE 2515 may include a predetermined score line (e.g., underneath and/or on top of the AICE as discussed with reference to FIGS. 2-4). In various implementations, a geometry of an end of the punch module 2520 may include a sealing surface. For example, when the sealing surface is brought into registration with the AICE 2515 after the punch module 2520 causes an aperture to be formed in the AICE 2515 and the sealing surface contacts the AICE 2515, the sealing surface may apply a radially outward force and/or a downward force on the AICE 2515 at the aperture to create a fluid seal between the AICE 2515 and the punch module 2520.

FIG. 26 depicts an illustrative can end. Can end 2600 includes a top surface 2605. The top surface includes a score 2610. In some implementations, the score 2610 may be advantageously punched through by a thumb 2615. For example, the score 2610 may, be advantageously punched through by any finger. The score 2610 may, for example, be punched through by an applied force equal to that of the thumb 2615 punching through.

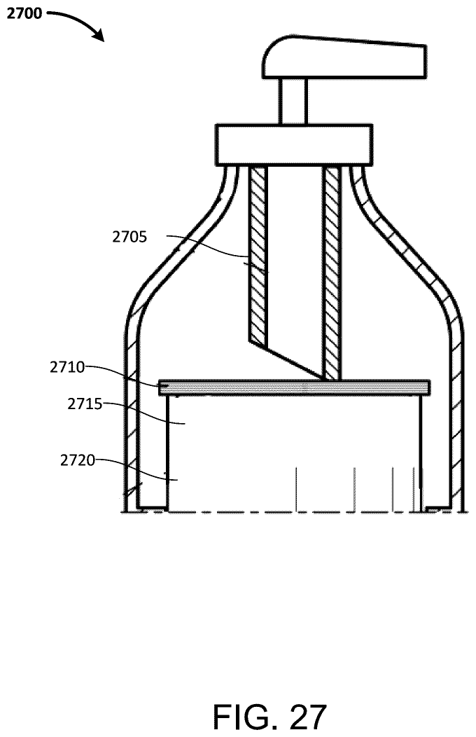

FIG. 27 depicts an illustrative engagement member. A dispensing body 2700 includes an engagement member 2705. In some implementations, a plastic film 2710 may span at least across an upper surface 2715 of a cup 2720. For example, the plastic film 2710 may span a cross section of a top portion of a cup 2720. The plastic film 2710 may, for example, have an area equal to a surface area of the upper surface of a cup 2715. In some examples, the plastic film 2710 may be punched through by the engagement member 2705. The engagement member 2705 punching through the plastic film 2710 may, for example, advantageously engage the dispensing body 2700 to the cup 2720.

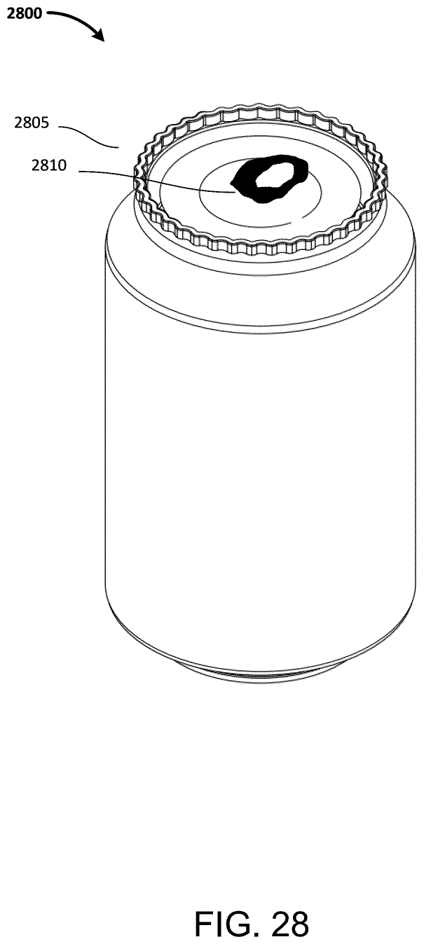

FIG. 28 depicts an illustrative can. A can 2805 includes an opening mechanism 2810. In some implementations, the opening mechanism 2810 may be a tab. The opening mechanism 2810 may, for example, be configured to apply force to open the can 2805.

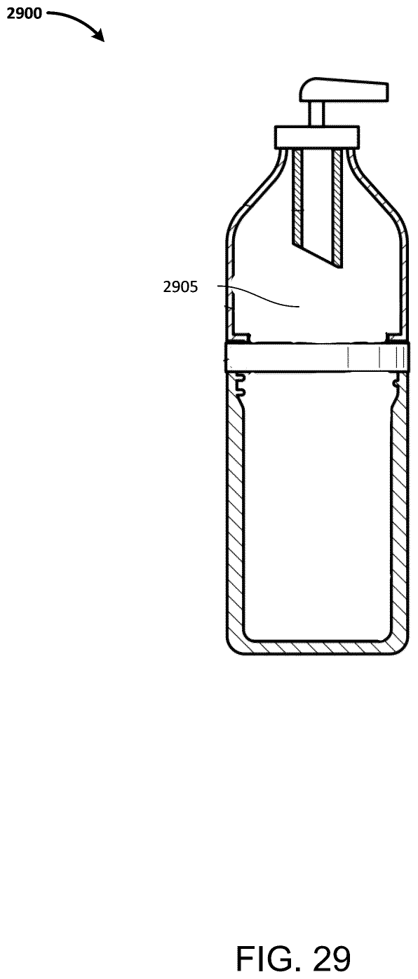

FIG. 29 depicts an illustrative dispenser. A dispenser 2900 includes a container 2905. In some implementations, the container 2905 may store a fluid. For example, the container 2905 may store soap and/or lotion. The container 2905 may, for example, be used to contain condiments.

Although various embodiments have been described with reference to the figures, other embodiments are possible.

In some implementations, a dispenser may be configured to dispense products in a container upside down. For example, the container may include an air permeable but product impermeable vent. For example, the vent may advantageously mitigate a vacuum created by dispensing the product.

In some implementations, a dispenser may include a noise making pump engine. For example, the noise making pump engine may include a shape that creates a distinctive sound. For example, the distinctive sound may advantageously inform a user that AICE is successfully opened.

In some implementations, an overall shape of the daisyless dispenser could be shaped to enhance or create a distinctive sound. For example, a punch of a dispenser may be configured to include a small angle (e.g., less than 5°, less than 10°). For example, when the dispenser breaks open an AICE score, a prolonged tearing at the score may create a distinctive sound.

In some implementations, the dispenser may include a whistle geometry. For example, the whistle geometry may generate a distinctive sound when the dispenser breaks open an AICE.

In some implementations, an AICE may include a two-staged score. For example, a first stage score may be easier to be broken open. For example, when the first stage score is broken open, a distinctive sound may be generated.

In various implementations, an AICE of a malleable can may include a score on an underside of the AICE. For example, the AICE may be provided with sealing geometry on the AICE. The sealing geometry may allow a dispenser releasably coupled to the can to seal to the can lid so that contents don't spill out. For example, the sealing geometry may form a continuous boundary. In some implementations, the sealing geometry may be a one-sided chamfer configured to engage with a mating geometry on the reusable dispenser. In some implementations, the sealing geometry may include a vee (e.g., going into a channel) and/or a two-sided chamfer.

In some implementations, the AICE may be pre-domed to induce a spring force when a dispenser is coupled to it. For example, the pred-domed AICE may urge upwards against the dispenser to maintain sealing between the dispenser and the AICE. For example, the AICE may be convex with a predetermined spring force. Springing of the AICE to add resistance to the seal.

A stress concentration score, for example, may be on the underside of the AICE. During a production process, compounds may be applied to the score after the score was created, in some implementations. The compounds may, for example, protect the alloy from degradation.

In some implementations, a tab may be eliminated on a normal beverage AICE. Accordingly, for example, normal can stock may be used because specialized fracture properties are not required. For example, by eliminating a pull tab on the AICE, the AICE material may not require fracture properties of virgin alloys. For example, the can stock may be used for the AICE. A dispenser may advantageously provide sufficient force to fracture the can without requiring specialized can stock. The can stock may not have variable fracture properties.

In some implementations, compounds may be added to the top of the AICE to allow a dispenser to glide more easily. For example, friction reducing compounds may be added to the top of the panel to lower friction. The friction reducing compounds may, for example, be applied to a sealing surface (e.g., to mating geometry with a dispenser). When a dispenser is rotated into place, for example, the friction reducing compound (e.g., PTFE, silicon) may advantageously allow a sealing portion of the dispenser (e.g., an O-ring) to rotate into place. For example, a rubber O-ring may engage the friction-reducing compound so that the O-ring may slide/rotate freely against the compound as the O-ring is axially advanced into compressive sealing contact with the sealing geometry of the AICE.

In some examples, a can assembly may include a can body, a top AICE, and a bottom AICE. The bottom AICE may, for example, be provided with a cross-sectional radial profile configured to receive an end of a pump straw. The pump straw may be cut to match the bottom profile of the can. In some implementations. a cross-sectional profile of the can bottom may be configured to funnel contents of the can towards a predetermined region (e.g., towards a center of the AICE, towards a side of the AICE). In some examples, the contents may be accessed by the pump straw. Funneling the remaining contents towards the center of the can assembly may collect the last drops of contents to reduce waste. For example, the can bottom may, for example, be v-shaped.

In some implementations, a can opening may include a wiper element. For example, the wiper element may include a curvature that matches a curvature of a pump. For example, the wiper element may advantageously remove content adhere to the pump when the pump is being removed from the can.

In some implementations, a can may include two chambers A and B. For example, the two chambers may be releasably coupled when a hammer C punches through a can opening of the chamber B. In some implementations, the chamber A may include water. For example, the chamber B may be a can containing a concentrated solution. For example, when the hammer C punches open the chamber B, the water in the chamber A may be mixed with the concentrated solution. In some implementations, the hammer C may punch and seal the chamber B. For example, a C-score of the chamber B may be angled to funnel water into the chamber B. For example, an output solution released from the pump may be a diluted solution of the content in the chamber B.

In some implementations, an AICE may include coupling threads on an outside of the can. For example, an opening feature may releasably screw along the coupling threads to couple and open the AICE.

In some implementations, an AICE may include an opening score punched open by an opening feature. For example, the AICE may include a safety seal. For example, the safety seal (e.g., the safety edge 1605) may provide a smooth full circle edge along the sealing edge between the score and the opening feature to advantageously reinforce the sealing edge. For example, the safety edge 1605 may be configured such that when the opening score is opened, sharp edges along the sealing edge 1605 may be pointing inwards to avoid harming users.

In some implementations, a container may include decorative images. In some implementations, a container may include a substantially transparent bottle containing a decorated can. In some implementations, to keep the decorative images in a desired position, the container may include an anti-rotation feature. For example, the anti-rotation feature may be a ridge built-in to the container. In some examples, the anti-rotation features may be “self-forge” in that a customer may self-align the decorative images (e.g., with a visual indicium at a bottom of the container) with the container.

One or more illustrative aspects may relate to a can end, including: an outer rim (102) defining a continuous top surface (101) of the can end, wherein the continuous top surface is configured to engage a dispensing body; a predetermined aperture (103) disposed at a center region of the continuous top surface; and, a structural rib (105) disposed inward from the outer rim, wherein the structural rib circumscribes the predetermined aperture, wherein the structural rib includes a vertical displacement perpendicular to a tangential plane of the continuous top surface of the can end, such that, during engagement, the dispensing body is self-aligned to a center of the continuous top surface.

One or more illustrative aspects may relate to a can end, including: a first aperture (1655) defined by a continuous rolling edge (1605); and, a score (1615) defining a second aperture (1660), wherein the second aperture is created by opening of the score, and wherein the first aperture is disposed outward of the second aperture when the can end is coupled to a can body.

One or more illustrative aspects may relate to a can end, wherein the score circumscribes an upward protrusion configured such that, when a dispensing body is inserted through the second aperture, the dispensing body presses against the upward protrusion and thereby displaces a portion of the can end circumscribed by the score entirely out from under the aperture.

One or more illustrative aspects may relate to a can end, including: a score (2405) concentrically disposed within an outer rim of the can end; and, at least one engagement protrusion (2410) circumscribed by the score, wherein the at least one engagement protrusion extends vertically from a top surface of the can end, such that when a flat opening module (2415) advances against the can end, a pressure (σ) may be induced at the at least one engagement protrusion.

One or more illustrative aspects may relate to a can end, including: a score (2010) concentrically disposed within an outer rim of the can end, wherein the score includes a check slot (2005a, 2005b) including a predetermined depth, wherein the predetermined depth is at least 25% less than a depth of the score.

One or more illustrative aspects may relate to a can end, wherein the score includes at least two evenly distributed check slots.

One or more illustrative aspects may relate to a can end, further includes a convex curved profile configured to curve away from a bottom surface of the can end, such that the curved profile resists a residual downward force at an engagement surface of the can end.

One or more illustrative aspects may relate to a dispensing body, including: an upper body (1145) includes a first threaded module (1160) and an engagement member configured to engage a top surface (130) of a can end; and, a lower body (1120) includes: an anti-rotation module (1125) configured to engage an outer rim (1130) of the can end; a second threaded module (1160) configured to releasably and rotatably coupled to the first threaded module the upper body; and, a lumen (1155) configured to allow the engagement member to traverse through when the upper body and the lower body is threadedly engaging with each other, wherein, in an engagement mode, the anti-rotation module is coupled to the outer rim and the upper body is rotated to threadedly engage with the lower body, such that the anti-rotation module prevents a rotational moment at the lower body with respect to the can end during a rotational motion of the upper body, such that the engagement member traverses axially through the lumen to open the can end.

One or more illustrative aspects may relate to a dispensing body (1200), including: a spacer module (1205); an upper body (1210) having an engagement member (1220); and, a lower body (1215), wherein the dispensing body includes a first height h1 from a bottom end of the engagement member to a bottom surface of the lower body; in a stowed mode, the upper body and the lower body are separated by the spacer module, such that the dispensing body is configured to entirely encapsulate a container (1225) including a predetermined second height h2>h1, wherein the spacer module includes a third height h3>(h2−h1), such that the engagement member is prevented from engaging a can end of the container, and, in an engagement mode, the spacer module is removed such that the engagement member engages to break open the container.

One or more illustrative aspects may relate to a dispensing body (1200), including: a spacer tube (1240) including a lumen of a spacer length; an upper body (1210) having an engagement member (1220) vertically extending from a top of the upper body; and, a lower body (1215), wherein: in a stowed mode, the engagement member is inserted through the spacer tube, such that the spacer tube contact a wall of the upper body at a predetermined point at a neck of the upper body, wherein a distance from the predetermined point to a bottom tip of the engagement member is less than the spacer length, such that the engagement member is prevented from engaging a can end of a container enclosed within the upper body and the lower body, and, in an engagement mode, the spacer tube is removed such that the engagement member engages to break open the container.

One or more illustrative aspects may relate to a dispensing body, wherein the lower body includes protrusions extending towards an internal cavity of the lower body, wherein the protrusion is configured to align the container within the internal cavity.

One or more illustrative aspects may relate to a dispensing body, wherein, in the stowed mode, the upper body further includes a removable shield disposed between the engagement member and the can end, wherein the removable shield spans at least across an upper surface of the can end. 13.

One or more illustrative aspects may relate to a dispensing body, including: an engagement member (1315) including a tooth member (1310), wherein the tooth member includes a first ramp (1330) and a second ramp (1325), wherein: the first ramp is configured to have a steeper slope than the second ramp to engage an engagement surface of a can end, and, the second ramp includes a gentler slope than the first ramp, such that the second ramp induces a local elevation as a function of a stress concentration distribution at the engagement surface.

One or more illustrative aspects may relate to a dispensing body, including: an engagement member (2520); and, a tubular seal (2525) coupled to the engagement member such that the engagement member is partially inserted within the tubular seal, wherein the tubular seal includes a radially extending profile (2530) from a proximal end to a distal end of the tubular seal, the radially extending profile configured to, upon coupling of the dispensing body to a can end (2515) such that the distal end engages the can end, flex outwardly along a horizontal plane (2535) of an upper surface of the can end. 16.

One or more illustrative aspects may relate to a dispensing body, further includes a tubular seal coupled to the engagement member such that the engagement member is partially inserted within the tubular seal, wherein the tubular seal includes a radially extending profile (2530) from a proximal end to a distal end of the tubular seal, the radially extending profile configured to, upon coupling of the dispensing body to the can end such that the distal end engages the can end, flex outwardly along a horizontal plane of an upper surface of the can end. 18.

One or more illustrative aspects may relate to a reusable dispensing system, including: the dispensing body; and, the can end wherein, in the stowed mode, the container is stored within the upper body and the lower body upside down.

One or more illustrative aspects may relate to a reusable dispensing system, including: a dip tube (610) includes a shaped end; and, a can body (605) includes configure to receive the dip tube inserted from a top surface of the can body toward a bottom surface of the can body, wherein the bottom surface of the can body includes a well region (620) including a continuous surface having laterally tilted subregions including at least one of the subregions is lower than other subregions, wherein the shaped end of the dip tube complements a profile of the at least one of the subregions that is lower than the other subregions.

One or more illustrative aspects may relate to a reusable dispensing system, further including the can end.

One or more illustrative aspects may relate to a reusable dispensing system, further including the dispensing body.

In some illustrative examples, a dispenser may be filled with a fluid or liquid substance without being contained in a can. For example, the substance that is filled in the dispenser, such as the dispenser described with reference to FIGS. 3, 7E, 9A, 9G, 10A-10E, and 11, is refilled by an end user without being contained inside of a can. In some applications, when the contents of a can in a dispenser are used up, the user can remove the can and fill the dispenser directly with a fluid such as water and/or a household cleaning product.

In the various applications, a pattern topping module, described with references to FIGS. 18A and 18B, is operated to form a sheet of material, for example, into a corrugated pattern, examples of which are described with reference to FIG. 18C. The formed member may be adapted to be received or securely retained against rotational forces when engaged by a corresponding receptacle. For example, some implementations may advantageously provide an interference fit to securely engage the formed member with a low durometer substrate (e.g., Styrofoam). In some examples, a receiving receptacle may be formed into a corresponding pattern shaped to receive the corrugated edges of the formed member. In some environments, the tool may be operated to create members formed to securely be engaged with substrates that are not correspondingly formed, such as a low durometer material, that can securely engage against rotational forces on the member.

In some embodiments, a can end, such as, for example, a can end described with reference to FIGS. 1A-5A, may be advantageously opened by an anvil that impacts the central aperture. In some implementations, a guide may be provided to orient and register the central aperture with the anvil such that the anvil impacts a selected target area on the central aperture. The anvil may be oriented in a downward direction aligned with the gravity vector. The anvil may be oriented parallel with the gravity vector in order to minimize loss of contents from the can after the opening of the can.

Some embodiments disclosed herein may, by way of example and not limitation, be described by one or more of the following clauses:

Clause 1. A can end, including: an outer rim (102) defining a continuous top surface (101) of the can end, wherein the continuous top surface is configured to engage a dispensing body; a predetermined aperture (103) disposed at a center region of the continuous top surface; and, a structural rib (105) disposed inward from the outer rim, wherein the structural rib circumscribes the predetermined aperture, wherein the structural rib includes a vertical displacement perpendicular to a tangential plane of the continuous top surface of the can end, such that, during engagement, the dispensing body is self-aligned to a center of the continuous top surface.

Clause 2. A can end, including: a first aperture (1655) defined by a continuous rolling edge (1605); and, a score (1615) defining a second aperture (1660), wherein the second aperture is created by opening of the score, and wherein the first aperture is disposed outward of the second aperture when the can end is coupled to a can body.

Clause 3. The can end of clause 2, wherein the score circumscribes an upward protrusion configured such that, when a dispensing body is inserted through the second aperture, the dispensing body presses against the upward protrusion and thereby displaces a portion of the can end circumscribed by the score entirely out from under the aperture.

Clause 4. A can end, including: a score (2405) concentrically disposed within an outer rim of the can end; and, at least one engagement protrusion (2410) circumscribed by the score, wherein the at least one engagement protrusion extends vertically from a top surface of the can end, such that when a flat opening module (2415) advances against the can end, a pressure (σ) may be induced at the at least one engagement protrusion.

Clause 5. A can end, including: a score (2010) concentrically disposed within an outer rim of the can end, wherein the score includes a check slot (2005a, 2005b) including a predetermined depth, wherein the predetermined depth is at least 25% less than a depth of the score.

Clause 6. The can end of clause 5, wherein the score includes at least two evenly distributed check slots.

Clause 7. The can end of any of clauses 1-6, further includes a convex curved profile configured to curve away from a bottom surface of the can end, such that the curved profile resists a residual downward force at an engagement surface of the can end.

Clause 8. A dispensing body, including: an upper body (1145) includes a first threaded module (1160) and an engagement member configured to engage a top surface (130) of a can end; and, a lower body (1120) includes: an anti-rotation module (1125) configured to engage an outer rim (1130) of the can end; a second threaded module (1160) configured to releasably and rotatably coupled to the first threaded module the upper body; and, a lumen (1155) configured to allow the engagement member to traverse through when the upper body and the lower body is threadedly engaging with each other, wherein, in an engagement mode, the anti-rotation module is coupled to the outer rim and the upper body is rotated to threadedly engage with the lower body, such that the anti-rotation module prevents a rotational moment at the lower body with respect to the can end during a rotational motion of the upper body, such that the engagement member traverses axially through the lumen to open the can end.

Clause 9. A dispensing body (1200), including: a spacer module (1205); an upper body (1210) having an engagement member (1220); and, a lower body (1215), wherein the dispensing body includes a first height hl from a bottom end of the engagement member to a bottom surface of the lower body; in a stowed mode, the upper body and the lower body are separated by the spacer module, such that the dispensing body is configured to entirely encapsulate a container (1225) including a predetermined second height h2>h1, wherein the spacer module includes a third height h3 >(h2−h1), such that the engagement member is prevented from engaging a can end of the container, and, in an engagement mode, the spacer module is removed such that the engagement member engages to break open the container.

Clause 10. A dispensing body (1200), including: a spacer tube (1240) including a lumen of a spacer length; an upper body (1210) having an engagement member (1220) vertically extending from a top of the upper body; and, a lower body (1215), wherein: in a stowed mode, the engagement member is inserted through the spacer tube, such that the spacer tube contact a wall of the upper body at a predetermined point at a neck of the upper body, wherein a distance from the predetermined point to a bottom tip of the engagement member is less than the spacer length, such that the engagement member is prevented from engaging a can end of a container enclosed within the upper body and the lower body, and, in an engagement mode, the spacer tube is removed such that the engagement member engages to break open the container.

Clause 11. The dispensing body of any of clauses 9-10, wherein the lower body includes protrusions extending towards an internal cavity of the lower body, wherein the protrusion is configured to align the container within the internal cavity.

Clause 12. The dispensing body of any of clauses 9-10, wherein, in the stowed mode, the upper body further includes a removable shield disposed between the engagement member and the can end, wherein the removable shield spans at least across an upper surface of the can end. 13.

Clause 14. A dispensing body, including: an engagement member (1315) including a tooth member (1310), wherein the tooth member includes a first ramp (1330) and a second ramp (1325), wherein: the first ramp is configured to have a steeper slope than the second ramp to engage an engagement surface of a can end, and, the second ramp includes a gentler slope than the first ramp, such that the second ramp induces a local elevation as a function of a stress concentration distribution at the engagement surface.

Clause 15. A dispensing body, including: an engagement member (2520); and, a tubular seal (2525) coupled to the engagement member such that the engagement member is partially inserted within the tubular seal, wherein the tubular seal includes a radially extending profile (2530) from a proximal end to a distal end of the tubular seal, the radially extending profile configured to, upon coupling of the dispensing body to a can end (2515) such that the distal end engages the can end, flex outwardly along a horizontal plane (2535) of an upper surface of the can end. 16.

Clause 17. The dispensing body of any of clauses 8-13, further includes a tubular seal coupled to the engagement member such that the engagement member is partially inserted within the tubular seal, wherein the tubular seal includes a radially extending profile (2530) from a proximal end to a distal end of the tubular seal, the radially extending profile configured to, upon coupling of the dispensing body to the can end such that the distal end engages the can end, flex outwardly along a horizontal plane of an upper surface of the can end. 18.

Clause 19. A reusable dispensing system, including: the dispensing body of clause 9; and, the can end of any of claims 1-7 wherein, in the stowed mode, the container is stored within the upper body and the lower body upside down.

Clause 20. A reusable dispensing system, including: a dip tube (610) includes a shaped end; and, a can body (605) includes configure to receive the dip tube inserted from a top surface of the can body toward a bottom surface of the can body, wherein the bottom surface of the can body includes a well region (620) including a continuous surface having laterally tilted subregions including at least one of the subregions is lower than other subregions, wherein the shaped end of the dip tube complements a profile of the at least one of the subregions that is lower than the other subregions.

Clause 21. The reusable dispensing system of clause 17, further including the can end of any of claims 1-7.

Clause 22. The reusable dispensing system of clause 17, further including the dispensing body of any of claims 8-15.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. The can end of claim 5,
wherein the outer rim (102) defines a continuous top surface (101) of the can end, wherein the continuous top surface is configured to engage a dispensing body; and,
the can end further comprises:
a predetermined aperture (103) disposed at a center region of the continuous top surface; and,
a structural rib (105) disposed inward from the outer rim, wherein the structural rib circumscribes the predetermined aperture, wherein the structural rib comprises a vertical displacement perpendicular to a tangential plane of the continuous top surface of the can end, such that, during engagement, the dispensing body is self-aligned to a center of the continuous top surface.

2. The can end of claim 5, further comprising:
a first aperture (1655) defined by a continuous rolling edge (1605); and,
a score (1615) defining a second aperture (1660), wherein the second aperture is created by opening of the score, and wherein the first aperture is disposed outward of the second aperture when the can end is coupled to a can body.

3. The can end of claim 2, wherein the score circumscribes an upward protrusion configured such that, when a dispensing body is inserted through the second aperture, the dispensing body presses against the upward protrusion and thereby displaces a portion of the can end circumscribed by the score entirely out from under the aperture.

4. A can end, comprising:
a score concentrically disposed within an outer rim of the can end; and,
at least one engagement protrusion circumscribed by the score, wherein the at least one engagement protrusion extends vertically from a top surface of the can end, such that when a flat opening module advances against the can end, a pressure is induced at the at least one engagement protrusion.

5. A can end, comprising:
a score concentrically disposed within an outer rim of the can end, wherein the score comprises a check slot comprising a predetermined depth, wherein the predetermined depth is at least 25% less than a depth of the score.

6. The can end of claim 5, wherein the score comprises at least two evenly distributed check slots.

7. The can end of claim 5, further comprising a convex curved profile configured to extend away from a bottom surface of the can end, such that the curved profile resists a residual downward force at an engagement surface of the can end.

8. The can end of claim 5, further comprising a top surface, and wherein at least the outer rim is configured for use with a dispensing body, wherein the dispensing body comprises:
an upper body comprising a first threaded module and an engagement member configured to engage the top surface of the can end; and,
a lower body comprising:
an anti-rotation module configured to engage the outer rim of the can end;
a second threaded module configured to releasably and rotatably coupled to the first threaded module the upper body; and,
a lumen configured to allow the engagement member to traverse through when the upper body and the lower body is threadedly engaging with each other, wherein, in an engagement mode, the anti-rotation module is coupled to the outer rim and the upper body is rotated to threadedly engage with the lower body, such that the anti-rotation module prevents a rotational moment at the lower body with respect to the can end during a rotational motion of the upper body, such that the engagement member traverses axially through the lumen to open the can end.

9-13. (canceled)

14. The can end of claim 5, wherein an upper surface of the can end radially exterior to the score is configured to sealingly engage with a dispensing body, wherein the dispensing body comprises:
an engagement member; and,
a tubular seal coupled to the engagement member such that the engagement member is partially inserted within the tubular seal, wherein the tubular seal comprises a radially extending profile from a proximal end to a distal end of the tubular seal, the radially extending profile configured to, upon coupling of the dispensing body to the can end such that the distal end engages the can end, flex outwardly along a horizontal plane of the upper surface of the can end.

15-19. (canceled)

20. The can end of claim 5, wherein a length of the check slot is at least 0.24 inches.

21. The can end of claim 5, wherein a length of the check slot is no more than 0.26 inches.

22. The can end of claim 5, wherein a score residual of the score is at least 0.0037 inches.

23. The can end of claim 5, wherein a score residual of the score is no more than 0.0040 inches.

24. The can end of claim 5, wherein a check slot residual of the check slot is at least 0.0054 inches.

25. The can end of claim 5, wherein a check slot residual of the check slot is no more than 0.0060 inches.

26. The can end of claim 5, wherein:
the check slot is a first check slot at a first location in the score, and
the score further comprises a second check slot at a second location in the score separated from the first location.

27. The can end of claim 26, wherein the first check slot and the second check slot are separated by a predetermined angular position.

28. The can end of claim 27, wherein the predetermined angular position is at least 90 degrees, as measured from a center of the score.

29. The can end of claim 26, wherein the score defines a panel, and the first check slot and the second check slot are configured such that, when a dispenser applies a localized stress concentration along a path adjacent to the score, wherein the stress concentration increases as the dispenser progresses along the path, when the first check slot fails so that the panel is separated from the can end along the first check slot, then the second check slot retains the panel in connection with the can end.

30. The can end of claim 5, wherein the score defines a closed path.

31. The can end of claim 5, wherein the score is circular.
